(19) United States
(12) Patent Application Publication
(10) Pub. No.: US 2024/0371074 A1
(43) Pub. Date: Nov. 7, 2024

(54) GRAPHICS PROCESSING

(71) Applicant: Arm Limited, Cambridge (GB)

(72) Inventors: Richard Edward Bruce, Great Shelford (GB); Jakob Axel Fries, Lund (SE)

(73) Assignee: Arm Limited, Cambridge (GB)

(21) Appl. No.: 18/602,583

(22) Filed: Mar. 12, 2024

(30) Foreign Application Priority Data
May 3, 2023 (GB) 2306546.9

(51) Int. Cl. G06T 15/06; G06T 1/20; G06T 15/00; G06T 17/10

(52) U.S. Cl. CPC G06T 15/06; G06T 1/20; G06T 15/005; G06T 17/10; G06T 2200/28; G06T 2210/21

(57) ABSTRACT

A graphics processor that is operable to perform ray tracing is disclosed. When it is determined that a ray intersects a volume represented by a node of a ray tracing acceleration data structure that is associated with a bounding volume primitive, the ray is not tested against the bounding volume primitive to determine whether the ray intersects the bounding volume primitive.

### BACKGROUND

The technology described herein relates to graphics processing systems, and in particular to the rendering of frames (images) for display using ray tracing.

FIG. 1 shows an exemplary system on-chip (SoC) graphics processing system 8 that comprises a host processor in the form of a central processing unit (CPU) 1, a graphics processor (GPU) 2, a display processor 3 and a memory controller 5.

As shown in FIG. 1, these units communicate via an interconnect 4 and have access to off-chip memory 6. In this system, the graphics processor 2 will render frames (images) to be displayed, and the display processor 3 will then provide the frames to a display panel 7 for display.

In use of this system, an application 13 such as a game, executing on the host processor (CPU) 1 will, for example, require the display of frames on the display panel 7. To do this, the application will submit appropriate commands and data to a driver 11 for the graphics processor 2 that is executing on the CPU 1. The driver 11 will then generate appropriate commands and data to cause the graphics processor 2 to render appropriate frames for display and to store those frames in appropriate frame buffers, e.g. in the main memory 6. The display processor 3 will then read those frames into a buffer for the display from where they are then read out and displayed on the display panel 7 of the display.

One rendering process that may be performed by a graphics processor is so-called “ray tracing”. Ray tracing is a rendering process which involves tracing the paths of rays of light from a viewpoint (sometimes referred to as a “camera”) back through sampling positions in an image plane into a scene, and simulating the effect of the interaction between the rays and objects in the scene. The output data value for a sampling position in the image (plane), is determined based on the object(s) in the scene intersected by the ray passing through the sampling position, and the properties of the surfaces of those objects. The ray tracing calculation is complex, and involves determining, for each sampling position, a set of objects within the scene which a ray passing through the sampling position intersects.

FIG. 2 illustrates an exemplary “full” ray tracing process. A ray 20 (the “primary ray”) is cast backward from a viewpoint 21 (e.g. camera position) through a sampling position 22 in an image plane (frame) 23 into the scene that is being rendered. The point 24 at which the ray 20 first intersects an object in the scene is identified. This first intersection will be with the object in the scene closest to the sampling position. A secondary ray in the form of shadow ray 26 may be cast from the first intersection point 24 to a light source 27. Depending upon the material of the surface of the object, another secondary ray in the form of reflected ray 28 may be traced from the intersection point 24. If the object is, at least to some degree, transparent, then a refracted secondary ray may be considered.

In this example, the first intersected object is represented by a set (e.g. mesh) of triangle primitives, and the ray 20 is found to intersect a triangle primitive 25 representing the object. However, other forms of geometry may be used. Objects may, for example, be represented using bounding volume primitives and/or by a procedure (program instructions). For example, in ray tracing in Vulkan, an object may be represented by a set (e.g. mesh) of triangle primitives, or an axis aligned bounding box (AABB) primitive may be used to indicate a volume within which a procedural object is defined. In this latter case, when a ray is found to intersect the axis aligned bounding box (AABB) primitive, execution of a procedure (program instructions) defining the procedural object is triggered to determine whether the ray intersects the procedural object.

Ray tracing is considered to provide better, e.g. more realistic, physically accurate images than more traditional rasterisation rendering techniques, particularly in terms of the ability to capture reflection, refraction, shadows and lighting effects. However, ray tracing can be significantly more processing-intensive than traditional rasterisation.

The Applicants believe that there remains scope for improved techniques for performing ray tracing using a graphics processor.

### BRIEF DESCRIPTION OF THE DRAWINGS

Embodiments of the technology described herein will now be described by way of example only and with reference to the accompanying drawings, in which:

FIG. 1 shows an exemplary graphics processing system;

FIG. 2 is a schematic diagram illustrating a “full” ray tracing process;

FIG. 3A and FIG. 3B show exemplary ray tracing acceleration data structures;

FIG. 4A and FIG. 4B are flow charts illustrating embodiments of a full ray tracing process;

FIG. 5 is a schematic diagram illustrating a “hybrid” ray tracing process;

FIG. 6 shows schematically an embodiment of a graphics processor that can be operated in the manner of the technology described herein;

FIG. 7 shows schematically in more detail elements of a graphics processor that can be operated in the manner of the technology described herein;

FIG. 8A and FIG. 8B show schematically a stack layout that may be used for managing a ray tracing traversal operation;

FIG. 9 is a flowchart showing the operation of a graphics processor in accordance with embodiments;

FIG. 10A and FIG. 10B are flow charts illustrating embodiments of a ray tracing process;

FIG. 11A and FIG. 11B show schematically data structures that may be used to store ray tracing data in embodiments; and

FIG. 12 shows schematically nodes of a ray tracing acceleration data structure that represents axis aligned bounding box (AABB) primitives, in accordance with embodiments.

### DETAILED DESCRIPTION

A first embodiment of the technology described herein comprises a method of operating a graphics processor that is operable to perform ray tracing using a ray tracing acceleration data structure that comprises a plurality of nodes, wherein each node of the ray tracing acceleration data structure represents a respective volume, and (each of) one or more of the nodes of the ray tracing acceleration data structure is associated with geometry that falls within the respective volume that the respective node represents;
wherein the graphics processor is operable to trace a ray by traversing the ray tracing acceleration data structure and testing the ray against volumes represented by nodes of the ray tracing acceleration data structure to determine whether the ray intersects the volumes, and when it is determined that the ray intersects a volume represented by a node of the ray tracing acceleration data structure that is associated with geometry that falls within the volume that the node represents, testing the ray against the geometry to determine whether the ray intersects the geometry;
the method comprising, the graphics processor:
when it is determined that a ray intersects a volume represented by a node of the ray tracing acceleration data structure that is associated with a bounding volume primitive, omitting testing the ray against the bounding volume primitive to determine whether the ray intersects the bounding volume primitive.

A second embodiment of the technology described herein comprises a graphics processor that is operable to perform ray tracing using a ray tracing acceleration data structure that comprises a plurality of nodes, wherein each node of the ray tracing acceleration data structure represents a respective volume, and (each of) one or more of the nodes of the ray tracing acceleration data structure is associated with geometry that falls within the respective volume that the respective node represents;
the graphics processor comprising:
a ray-volume intersection testing circuit operable to test a ray against a volume represented by a node of a ray tracing acceleration data structure to determine whether the ray intersects the volume;
a ray-geometry intersection testing circuit operable to test a ray against geometry that a node of a ray tracing acceleration data structure is associated with to determine whether the ray intersects the geometry; and
a ray tracing circuit operable to trace a ray by traversing a ray tracing acceleration data structure and causing the ray-volume intersection testing circuit to test the ray against volumes represented by nodes of the ray tracing acceleration data structure to determine whether the ray intersects the volumes, and when it is determined by the ray-volume intersection testing circuit that the ray intersects a volume represented by a node of the ray tracing acceleration data structure that is associated with geometry that falls within the volume that the node represents, cause the ray-geometry intersection testing circuit to test the ray against the geometry to determine whether the ray intersects the geometry;
wherein the graphics processor is operable to:
when it is determined by the ray-volume intersection testing circuit that a ray intersects a volume represented by a node of a ray tracing acceleration data structure that is associated with a bounding volume primitive, omit testing the ray against the bounding volume primitive to determine whether the ray intersects the bounding volume primitive.

The technology described herein is concerned with a graphics processor performing ray tracing. In the technology described herein, the graphics processor (comprises a ray tracing circuit that) is operable to perform ray tracing by traversing a ray tracing acceleration data structure. The ray tracing acceleration data structure comprises a plurality of nodes, with each node of the ray tracing acceleration data structure representing a respective volume, and at least some of the nodes being associated with geometry that falls within the respective volume.

In embodiments, as will be discussed in more detail below, the ray tracing acceleration data structure is arranged as a hierarchy of nodes representing a hierarchy of volumes, e.g. and in embodiments, the ray tracing acceleration data structure comprises one or more bounding volume hierarchies (BVHs). In embodiments, the ray tracing acceleration data structure comprises end (e.g. leaf) nodes that are each associated with (represent) a set of geometry defined within the respective volume that the end (e.g. leaf) node corresponds to.

The graphics processor (comprises a ray-volume intersection testing circuit that) is operable to test rays for intersection with volumes that are represented by the nodes of the ray tracing acceleration data structure (e.g. BVH). When a ray is found to intersect a node that is associated with geometry, e.g. when a ray is found to intersect an end (e.g. leaf) node having associated geometry, the ray may be tested for intersection with the geometry that the (e.g. end/leaf) node corresponds to by (a ray-geometry intersection testing circuit of) the graphics processor. The use of a ray tracing acceleration data structure in this manner can speed up the determination of which (if any) geometry is intersected by a ray, and thus can significantly accelerate ray tracing.

In embodiments of the technology described herein, the geometry represented by the ray tracing acceleration data structure comprises graphics primitives, in embodiments in the form of polygons, such as triangles, or bounding volume primitives, e.g. in the form of axis aligned bounding box (AABB) primitives. In embodiments, as will be discussed in more detail below, a bounding volume (e.g. AABB) primitive indicates a volume within which further geometry, e.g. an object defined by a procedure (program instructions), can be defined. Defining an object procedurally can allow geometry to be more precisely represented, e.g. as compared to representing an object by polygons, e.g. triangles.

In embodiments of the technology described herein, an end (e.g. leaf) node of the ray tracing acceleration data structure (e.g. BVH) can be associated with either one or more polygons, e.g. triangles, or one or more bounding volume (e.g. AABB) primitives, and in the case of a ray being found to intersect a (e.g. end/leaf) node that is associated with one or more polygons, e.g. triangle primitives, the ray is tested against (each of) the one or more polygons, e.g. triangle primitives, to determine whether the ray intersects (any of) the one or more polygons, e.g. triangle primitives, by (the ray-geometry intersection testing circuit of) the graphics processor.

In the technology described herein, in the case of a ray being found to intersect a (e.g. end/leaf) node that is associated with one or more bounding volume primitives (e.g. an axis aligned bounding box (AABB) primitive), however, the testing of the ray against (each of) the one or more bounding volume (e.g. AABB) primitives to determine whether the ray intersects (any of) the one or more bounding volume (e.g. AABB) primitives is omitted, i.e. is not performed.

The inventors have realised that, rather than performing a ray-bounding volume (e.g. AABB) primitive intersection test to determine whether a ray intersects a bounding volume (e.g. AABB) primitive, it is possible to instead rely on the result of a ray-volume intersection test that determines whether the ray intersects the volume represented by the associated (e.g. end/leaf) node of the ray tracing acceleration data structure that the bounding volume (e.g. AABB) primitive falls within. Put another way, the inventors have realised that if a ray is found to intersect a node volume that a bounding volume (e.g. AABB) primitive falls within, it is reasonable to assume that the ray will intersect the bounding volume (e.g. AABB) primitive (and accordingly to omit testing the ray against the bounding volume (e.g. AABB) primitive to determine whether this is actually the case).

As will be discussed in more detail below, the inventors have found that even though this assumption may result in it being assumed that a ray intersects a bounding volume primitive when in fact that is not the case, omitting performing ray-bounding volume primitive testing can reduce overall processing requirements. Furthermore, the technology described herein allows ray-bounding volume (e.g. AABB) primitive intersection testing to be implemented without the need to provide a e.g. dedicated ray-bounding volume (e.g. AABB) primitive intersection testing circuit. This means that the overall complexity of the graphics processor circuitry required to implement the ray tracing traversal operation can be reduced. The technology described herein can accordingly reduce overall graphics processor area requirements and energy consumption.

It will be appreciated, therefore, that the technology described herein can provide an improved graphics processor and ray tracing method.

The graphics processor of the technology described herein is operable to perform ray tracing, e.g. and in embodiments, in order to generate a render output, such as a frame for display, e.g. that represent a view of a scene comprising one or more objects. The graphics processor may typically generate plural render outputs, e.g. a series of frames.

A render output will typically comprise an array of data elements (sampling points) (e.g. pixels), for each of which appropriate render output data (e.g. a set of colour value data) is generated by the graphics processor. A render output data may comprise colour data, for example, a set of red, green and blue, RGB values and a transparency (alpha, a) value.

The (ray tracing circuit of the) graphics processor may trace individual rays separately. In embodiments, the graphics processor is operable to trace a group of plural rays together. Thus, in embodiments, the ray tracing circuit traces a group of plural rays together, e.g. and in embodiments such that all of the rays in a group of rays traverse (visit) the nodes of the ray tracing acceleration data structure in the same node order. In embodiments, the arrangement in this regard is substantially as described in US 2022/0392147, the entire contents of which is incorporated herein by reference.

The graphics processor may carry out ray tracing graphics processing operations in any suitable and desired manner. In embodiments, the (e.g. ray tracing circuit of the) graphics processor comprises one or more programmable execution units (e.g. shader cores) operable to execute programs to perform graphics processing operations, and ray-tracing based rendering is triggered and performed by a programmable execution unit of the graphics processor executing a graphics processing (e.g. shader) program that causes the programmable execution unit to perform ray tracing rendering processes.

In embodiments, a program is executed by a group of plural execution threads together, e.g. and in embodiments, one execution thread for each ray in a group of rays being traced together. Thus, in embodiments, each ray is traced by a respective execution thread executing an appropriate (e.g. shader) program.

Typically in ray tracing, one or more rays are used to render a (each) sampling position in the render output, and for each ray being traced, it is determined which geometry that is defined for the render output is intersected by the ray (if any). Geometry determined to be intersected by a ray may then be further processed, e.g. in order to determine a colour for the sampling position in question.

The geometry to be processed to generate a render output may comprise any suitable and desired graphics processing geometry. As already mentioned, in embodiments, the geometry that the ray tracing acceleration data structure represents comprises graphics primitives, in embodiments in the form of (two-dimensional) polygons, such as triangles (e.g. a mesh of triangles), or (three-dimensional) bounding volume primitives.

A bounding volume primitive may be in the form of a bounding box, e.g. a parallelepiped, e.g. cuboid. In embodiments, a (each) bounding volume primitive is an axis aligned bounding box (AABB) primitive. Other bounding volumes, such as bounding spheres, would be possible. In embodiments, a bounding volume primitive indicates a volume within which further geometry, such as a geometry object defined by a procedure (program instructions), is defined. Such a procedural object may be, for example, an object that cannot be (adequately) represented by polygons (e.g. triangles), such as a perfect sphere, etc.

Determining which geometry (if any) is intersected by a ray can be performed in any suitable and desired manner. In general, there may be many millions of graphics primitives within a given scene, and millions of rays to be tested, such that it is not normally practical to test every ray against each and every graphics primitive. To speed up the ray tracing operation, embodiments of the technology described herein use a ray tracing acceleration data structure, such as a bounding volume hierarchy (BVH), that is representative of the distribution of the geometry in the (e.g.) scene that is to be rendered to determine the intersection of rays with geometry (e.g. objects) in the scene being rendered (and then render sampling positions in the output rendered frame representing the scene accordingly).

Ray tracing according to embodiments of the technology described herein therefore generally comprises (the ray tracing circuit) performing a traversal of the ray tracing acceleration data structure, which traversal involves testing rays for intersection with volumes represented by different nodes of the ray tracing acceleration data structure in order to determine which geometry may be intersected by which rays for a sampling position in the render output, and which geometry therefore needs to be further processed for the rays for the sampling position.

A ray tracing acceleration data structure can be arranged in any suitable and desired manner. In embodiments, the ray tracing acceleration data structure comprises a tree structure that is configured such that each end (e.g. leaf) node of the tree structure represents a set of geometry (e.g. primitives) defined within the respective volume that the end (e.g. leaf) node corresponds to, and with the other (non-leaf) nodes representing hierarchically-arranged larger volumes up to a root node at the top level of the tree structure that represents an overall volume for the render output (e.g. scene) in question that the tree structure corresponds to.

In embodiments, an (each) end (e.g. leaf) node is associated with (corresponds to) either (a set of) one or more polygons (e.g. triangle primitives), or (a set of) one or more bounding volume primitives (e.g. bounding box primitives, e.g. axis aligned bounding box (AABB) primitives). In particular embodiments, an (each) end (e.g. leaf) node is associated with (corresponds to) either three triangle primitives, or one bounding box (e.g. AABB) primitive, but other arrangements, e.g. numbers of primitives, would be possible.

Each non-leaf node is in embodiments a parent node for a respective set of plural child nodes with the parent node volume encompassing the volumes of its respective child nodes. In embodiments, each (non-leaf) node is associated with a respective plurality of child node volumes, each representing a (in embodiments non-overlapping) sub-volume within the overall volume represented by the (non-leaf) node in question.

Thus, in embodiments, at least one of the nodes of the ray tracing acceleration data structure is associated with a respective set of plural child nodes. In embodiments, there are multiple such nodes in the ray tracing acceleration data structure. These nodes may be referred to as “parent” nodes. They may also be referred to an “internal” or “non-leaf” nodes, for example, depending on the arrangement of the ray tracing acceleration data structure.

Thus, in embodiments, traversal of the ray tracing acceleration data structure comprises (the ray tracing circuit) proceeding down the “branches” of the tree structure and testing the rays against the child volumes associated with a node at a first level of the tree structure to thereby determine which child nodes in the next level of the tree structure should be tested, and so on, down to the level of the respective end (e.g. leaf) nodes at the end of the branches of the tree structure.

A ray tracing acceleration data structure could comprise, e.g. a single tree structure (e.g. BVH) representing the entirety of a scene being rendered. In embodiments, a ray tracing acceleration data structure comprises multiple “levels” of tree structures (e.g. BVHs).

For example, in embodiments, the ray tracing acceleration data structure comprises one or more “lowest level” tree structures (e.g. BVHs) (which may also be referred to as a “bottom level acceleration structure (BLAS)”), that each represent a respective instance or object within a scene to be rendered, and a “highest level” tree structure (e.g. BVH) (which may also be referred to as a “top level acceleration structure (TLAS)”) that refers to the one or more “lowest level” tree structures. In this case, each “lowest level” tree structure may comprise end (e.g. leaf) nodes that represent a set of geometry (e.g. primitives) associated with the respective instance or object, and the “highest level” tree structure may comprise end (e.g. leaf) nodes that point to, e.g. the root node of, one or more of the one or more “lowest level” tree structures.

In embodiments, a (each) “lowest level” tree structure (e.g. BLAS) either represents polygon geometry (e.g. triangle primitives), or bounding volume primitive geometry (e.g. bounding box primitives, e.g. AABB primitives).

In embodiments, each “lowest level” tree structure (e.g. BLAS) is defined in a space that is associated with the respective instance or object, e.g. a model space, whereas the “highest level” tree structure (e.g. TLAS) is defined in a space that is associated with the entire scene, e.g. a world space. In this case, each “highest level” tree structure end (e.g. leaf) node may include information indicative of an appropriate transformation between the respective spaces. Correspondingly, traversal of the ray tracing acceleration data structure may comprise, when an end (e.g. leaf) node of the “highest level” tree structure is reached, applying a transformation indicated by the end (e.g. leaf) node, and then beginning traversal of the corresponding “lowest level” tree structure.

Once it has been determined by performing a traversal operation for a ray which end (e.g. leaf) nodes represent geometry that may be intersected by a ray, the actual geometry intersections for the ray for the geometry that occupies the volumes associated with the intersected end (e.g. leaf) nodes can be determined accordingly, e.g. by testing the ray for intersection with the individual units of geometry (e.g. primitives) defined for the render output (e.g. scene) that occupy the volumes associated with the end (e.g. leaf) nodes.

Thereafter, once the geometry intersections for the rays being used to render a sampling position have been determined, it can then be (and in embodiments is) determined what appearance the sampling position should have, and the sampling position rendered accordingly.

Thus, in embodiments, the (e.g. ray tracing circuit of the) graphics processor is operable to perform ray-volume intersection tests in which it is determined whether a ray intersects a volume represented by a node of the ray tracing acceleration data structure, and ray-geometry (e.g. primitive) intersection tests in which it is determined whether a ray intersects geometry (e.g. a primitive) occupying a volume represented by a node of the ray tracing acceleration data structure.

Ray-volume intersection tests may be performed by a programmable execution unit of the graphics processor executing an appropriate program. In embodiments, the (e.g. ray tracing circuit of the) graphics processor comprises a ray-volume intersection testing circuit that is operable to perform ray-volume intersection tests, and that is in embodiments a (substantially) fixed function circuit. In embodiments, the execution of an appropriate program instruction triggers the programmable execution unit to message the ray-volume intersection testing circuit to cause the ray-volume intersection testing circuit to perform a ray-volume intersection test. The use of dedicated, e.g. fixed function, circuitry can improve overall performance.

Similarly, ray-geometry (e.g. primitive) intersection tests may be performed by a programmable execution unit of the graphics processor executing an appropriate program, and/or the (e.g. ray tracing circuit of the) graphics processor may comprise a ray-geometry (e.g. primitive) intersection testing circuit that is operable to perform ray-geometry (e.g. primitive) intersection tests, and that is in embodiments a (substantially) fixed function circuit. The execution of an appropriate program instruction may trigger the programmable execution unit to message the ray-geometry (e.g. primitive) intersection testing circuit to cause the ray-geometry (e.g. primitive) intersection testing circuit to perform a ray-geometry (e.g. primitive) intersection test.

In the technology described herein, ray-bounding volume (e.g. AABB) primitive intersection tests are not performed. Thus, in embodiments, ray-geometry intersection tests are only performed in respect of geometry other than bounding volume primitives. For example, and in embodiments, ray-primitive intersection tests are (only) performed in respect of polygons, e.g. triangle primitives.

Thus, the ray-geometry (e.g. primitive) intersection testing circuit should not, and in embodiments does not, test rays for intersection with bounding volume (e.g. AABB) primitives. In embodiments, the ray-geometry (e.g. primitive) intersection testing circuit is a (e.g. substantially fixed function) ray-polygon intersection testing circuit that is operable to test rays against (only) polygons to determine whether the rays intersect the polygons. In embodiments, the ray-geometry intersection testing circuit is a (e.g. substantially fixed function) ray-triangle intersection testing circuit that is operable to test rays against (only) triangle primitives to determine whether the rays intersect the triangle primitives.

Where a bounding volume (e.g. AABB) primitive indicates a volume within which a procedural object is defined, a ray-procedural object intersection test is in embodiments performed by a programmable execution unit of the (ray tracing circuit of the) graphics processor executing an appropriate program that defines the procedural object.

Thus, in embodiments, it is determined (by a programmable execution unit executing a program) whether a ray intersects a procedural object defined within a bounding volume primitive without (the ray-geometry intersection testing circuit) testing the ray against the bounding volume primitive to determine whether the ray intersects the bounding volume primitive.

Thus, in embodiments of the technology described herein, when it is determined (by the ray-volume intersection testing circuit) that a ray intersects a volume represented by a (e.g. end/leaf) node of the ray tracing acceleration data structure that is associated with a polygon (e.g. triangle primitive), the ray is tested against the polygon (e.g. triangle primitive) (by the ray-geometry intersection testing circuit) to determine whether the ray intersects the polygon (e.g. triangle primitive). In embodiments, when it is determined (by the ray-volume intersection testing circuit) that a ray intersects a volume represented by a (e.g. end/leaf) node of the ray tracing acceleration data structure that is associated with a bounding volume primitive (e.g. bounding box, e.g. AABB, primitive), it is determined (by (a programmable execution unit of) the graphics processor executing a program) whether the ray intersects further geometry, e.g. a procedural object, defined within the bounding volume primitive without (the ray-geometry intersection testing circuit) testing the ray against the bounding volume primitive to determine whether the ray intersects the bounding volume primitive.

Polygon (e.g. triangle primitive) geometry can be processed in any suitable and desired manner. In embodiments, for a (each) (e.g. end/leaf) node of the ray tracing acceleration data structure that is associated with one or more polygons (e.g. (three) triangle primitives), polygon geometry data indicative of the one or more polygons (e.g. (three) triangle primitives) is stored. Then, when a ray-polygon (e.g. triangle primitive) intersection test is to be performed (by the ray-geometry intersection testing circuit), the polygon geometry data stored for the node associated with the polygon to be tested is loaded by the graphics processor, and used to perform the ray-polygon (e.g. triangle primitive) intersection test.

The (polygon) geometry data may be stored in storage that is local to (e.g. on the same chip as) the graphics processor, and/or in storage that is external (e.g. on a different chip) to the graphics processor. In embodiments, the geometry data is stored in a (e.g. main) memory of a graphics processing system that the graphics processor is part of. Thus, embodiments of the technology described herein relate to a graphics processing system that comprises the graphics processor and a memory. In embodiments, the graphics processor comprises a cache system via which it can communicate with the memory, and via which geometry data may be loaded.

The polygon geometry data stored for a (e.g. end/leaf) node associated with one or more polygons (e.g. (three) triangle primitives) may comprise any suitable and desired data. It in embodiments comprises (at least) data indicating vertex positions of the one or more polygons (e.g. (three) triangle primitives). It may (also) comprise state data indicating whether or not a (each) polygon is valid. In embodiments, the polygon geometry data (further) comprises data that can be used (by the graphics processor) to determine how to further process a (each) polygon, e.g. and in embodiments, data indicating whether or not a (each) polygon is opaque, and/or indicating a material that a (each) polygon represents.

In embodiments, a predefined data structure is used to store polygon geometry data for a node. Thus, in embodiments, a predefined data structure is used that is configured to store (at least) information indicating a position of each vertex of each polygon of a set of one or more polygons. In embodiments, the predefined data structure can store vertex positions of (up to) three triangle primitives. The predefined data structure may, for example and in embodiments, comprise fields that can e.g. each store a respective vertex coordinate. The predefined data structure may (further) comprise fields that can store other polygon geometry data, such as state data etc., e.g. as described above.

In embodiments, the predefined data structure is configured to facilitate efficient memory access. For example, and in embodiments, the predefined data structure has a particular, in embodiments selected, in embodiments predetermined, in embodiments fixed, size.

In embodiments, the predefined data structure that has a size that is equal to an integer number of cache entries (e.g. cache lines) of the cache system. For example, in the case of 64-byte cache entries, the predefined data structure may be 64-bytes, 128-bytes, etc., in size. In embodiments, the predefined data structure has a particular, in embodiments selected, in embodiments predetermined, in embodiments fixed, data layout. The data structure may, for example, be “sparsely packed”, e.g. so as to have the desired size.

Thus, embodiments of the technology described herein comprise (a geometry data loading circuit of) the graphics processor loading polygon geometry data from a predefined data structure stored for a (e.g. end/leaf) node of the ray tracing acceleration data structure, and (the ray-geometry intersection testing circuit of) the graphics processor using the loaded polygon geometry data to perform a ray-polygon (e.g. triangle primitive) intersection test.

Similarly, bounding volume/procedural object geometry can be processed in any suitable and desired manner. In embodiments of the technology described herein, the processing of bounding volume/procedural object geometry is performed in an equivalent manner to polygon (e.g. triangle primitive) geometry processing, e.g. and in embodiments, such that the same circuits can be, and in embodiments are, used for different (both) geometry type processing.

Thus, in embodiments, for a (each) (e.g. end/leaf) node of the ray tracing acceleration data structure that is associated with a bounding volume (e.g. AABB) primitive (within which further geometry, e.g. a procedural object, is defined), geometry data is stored. Then, when (e.g. ray-procedural object) intersection testing is to be performed, the geometry data stored for the node associated with the bounding volume primitive (within which the further geometry, e.g. procedural object, is defined) is loaded by (the geometry data loading circuit of) the graphics processor, and used e.g. to perform the (e.g. ray-procedural object) intersection testing. The geometry data may, for example and in embodiments, be used to determine whether the ray intersects, and/or how the ray should interact with, the further geometry, e.g. procedural object, defined within the bounding volume primitive.

Bounding volume/procedural object geometry data could be stored differently to polygon geometry data. However, in embodiments of the technology described herein, the same predefined data structure that is used to store polygon geometry data is used to store bounding volume/procedural object geometry data.

Thus, in embodiments, bounding volume/procedural object geometry data is stored using a predefined data structure that has the same set of fields as a predefined data structure used to store polygon geometry data. In embodiments, the same/corresponding field(s) is used to store bounding volume/procedural object geometry data as is used to store the same/corresponding polygon geometry data. In embodiments, the same amount of storage space and/or the same data layout is used to store bounding volume/procedural object geometry data for a (each) (e.g. end/leaf) node as is used to store polygon (e.g. triangle) geometry data for a (each) (e.g. end/leaf) node. In embodiments, the same predefined data structure/amount of storage/data layout is used for (geometry data for) each (e.g. BLAS) end (e.g. leaf) node of the ray tracing acceleration data structure.

This can facilitate common data processing for different (both) geometry types, and can thus (further) reduce the overall complexity of the graphics processor circuitry required to implement the ray tracing traversal operation.

It is thought that the idea of storing polygon geometry data and bounding volume/procedural object geometry data using the same predefined data structure may be novel and inventive in its own right.

Thus, another embodiment of the technology described herein comprises a method of operating a graphics processor that is operable to perform ray tracing using a ray tracing acceleration data structure that comprises a plurality of nodes, wherein each node of the ray tracing acceleration data structure represents a respective volume, and (each of) one or more of the nodes of the ray tracing acceleration data structure is associated with geometry that falls within the respective volume that the respective node represents;
wherein the graphics processor is operable to trace a ray by traversing the ray tracing acceleration data structure and testing the ray against volumes represented by nodes of the ray tracing acceleration data structure to determine whether the ray intersects the volumes, and when it is determined that the ray intersects a volume represented by a node of the ray tracing acceleration data structure that is associated with a polygon that falls within the volume that the node represents, load polygon geometry data stored for the node, and process geometry using the loaded polygon geometry data, wherein the polygon geometry data is stored using a predefined data structure;
the method comprising, the graphics processor:
tracing a ray by traversing a ray tracing acceleration data structure, and when it is determined that the ray intersects a volume represented by a node of the ray tracing acceleration data structure that is associated with a bounding volume primitive, loading (bounding volume primitive) geometry data stored for the node, and processing geometry using the loaded (bounding volume primitive) geometry data, wherein the (bounding volume primitive) geometry data is stored using the predefined data structure that is used to store polygon geometry data.

Another embodiment of the technology described herein comprises a graphics processor that is operable to perform ray tracing using a ray tracing acceleration data structure that comprises a plurality of nodes, wherein each node of the ray tracing acceleration data structure represents a respective volume, and (each of) one or more of the nodes of the ray tracing acceleration data structure is associated with geometry that falls within the respective volume that the respective node represents;
the graphics processor comprising:
a ray-volume intersection testing circuit operable to test a ray against a volume represented by a node of a ray tracing acceleration data structure to determine whether the ray intersects the volume;
a geometry data loading circuit operable to load polygon geometry data stored for a node of a ray tracing acceleration data structure, wherein the polygon geometry data is stored using a predefined data structure; and a ray tracing circuit operable to trace a ray by traversing the ray tracing acceleration data structure and causing the ray-volume intersection testing circuit to test the ray against volumes represented by nodes of the ray tracing acceleration data structure to determine whether the ray intersects the volumes, and when it is determined by the ray-volume intersection testing circuit that the ray intersects a volume represented by a node of the ray tracing acceleration data structure that is associated with a polygon that falls within the volume that the node represents, cause the geometry data loading circuit to load polygon geometry data stored for the node, and cause geometry to be processed using the loaded polygon geometry data;
wherein the graphics processor is operable to:
when it is determined by the ray-volume intersection testing circuit that a ray intersects a volume represented by a node of a ray tracing acceleration data structure that is associated with a bounding volume primitive, cause the geometry data loading circuit to load (bounding volume primitive) geometry data stored for the node, and cause geometry to be processed using the loaded (bounding volume primitive) geometry data, wherein the (bounding volume primitive) geometry data is stored using the predefined data structure that is used to store polygon geometry data.

These embodiments extend to the generation and storing of the geometry data.

Thus, another embodiment of the technology described herein comprises a method of providing a ray tracing acceleration data structure for use by a graphics processing system that includes a graphics processor that is operable to perform ray tracing using a ray tracing acceleration data structure that comprises a plurality of nodes, wherein each node of the ray tracing acceleration data structure represents a respective volume, and (each of) one or more of the nodes of the ray tracing acceleration data structure is associated with geometry that falls within the respective volume that the respective node represents;
wherein the graphics processor is operable to trace a ray by traversing the ray tracing acceleration data structure and testing the ray against volumes represented by nodes of the ray tracing acceleration data structure to determine whether the ray intersects the volumes, and when it is determined that the ray intersects a volume represented by a node of the ray tracing acceleration data structure that is associated with a polygon that falls within the volume that the node represents, load polygon geometry data stored for the node, and process geometry using the loaded polygon geometry data, wherein the polygon geometry data is stored using a predefined data structure;
the method comprising:
generating a ray tracing acceleration data structure for use by the graphics processor, wherein the ray tracing acceleration data structure comprises a plurality of nodes, wherein each node of the ray tracing acceleration data structure represents a respective volume, and (each of) one or more of the nodes of the ray tracing acceleration data structure is associated with a bounding volume primitive that falls within the respective volume that the respective node represents; and storing, for each node of the ray tracing acceleration data structure that is associated with a bounding volume primitive, (bounding volume primitive) geometry data using the predefined data structure that is used to store polygon geometry data.

Another embodiment of the technology described herein comprises a data (e.g. graphics) processing system operable to provide a ray tracing acceleration data structure for use by a graphics processor that is operable to perform ray tracing using a ray tracing acceleration data structure that comprises a plurality of nodes, wherein each node of the ray tracing acceleration data structure represents a respective volume, and (each of) one or more of the nodes of the ray tracing acceleration data structure is associated with geometry that falls within the respective volume that the respective node represents;
wherein the graphics processor is operable to trace a ray by traversing a ray tracing acceleration data structure and testing the ray against volumes represented by nodes of the ray tracing acceleration data structure to determine whether the ray intersects the volumes, and when it is determined that the ray intersects a volume represented by a node of the ray tracing acceleration data structure that is associated with a polygon that falls within the volume that the node represents, load polygon geometry data stored for the node, and process geometry using the loaded polygon geometry data, wherein the polygon geometry data is stored using a predefined data structure;
the data processing system comprising:
a ray tracing acceleration data structure generating circuit operable to generate a ray tracing acceleration data structure for use by the graphics processor, wherein the ray tracing acceleration data structure comprises a plurality of nodes, wherein each node of the ray tracing acceleration data structure represents a respective volume, and (each of) one or more of the nodes of the ray tracing acceleration data structure is associated with a bounding volume primitive that falls within the respective volume that the respective node represents; and a storing circuit operable to store, for each node of a ray tracing acceleration data structure generated by the ray tracing acceleration data structure generating circuit that is associated with a bounding volume primitive, (bounding volume primitive) geometry data using the predefined data structure that is used to store polygon geometry data.

These embodiments can, and in embodiments do, include one or more, and in embodiments all, features of other embodiments of the technology described herein, as appropriate. For example, in these embodiments, testing rays against bounding volume primitives to determine whether the rays intersect the bounding volume primitives may be omitted (not performed).

In these embodiments, the polygon geometry data stored for a node and the bounding volume/procedural object geometry data stored for a node should be, and in embodiments are, processed in a common manner and/or by the same circuits of the graphics processor/processing system. For example, in embodiments, the same address calculation circuit, and/or the same memory transactions, and/or the same cache system, and/or the same scheduling circuit, and/or the same data processing pipeline, is used.

Thus, in embodiments, the same geometry data loading circuit of the graphics processor loads polygon geometry data stored for a node of the ray tracing acceleration data structure that is associated with a polygon for processing, and loads bounding volume geometry data stored for a node of the ray tracing acceleration data structure that is associated with a bounding volume primitive for processing. In embodiments, the geometry data loading circuit loads both types of geometry data from the same memory. In embodiments, the geometry data loading circuit loads both types of geometry data via the same cache system of the graphics processor.

In embodiments, the same ray-volume intersection testing circuit and/or ray-geometry intersection testing circuit and/or programmable execution unit and/or ray tracing circuit of the graphics processor processes polygon geometry data, and processes bounding volume geometry data (loaded by the (same) geometry data loading circuit).

A (the) ray tracing acceleration data structure may be generated by the same graphics processor that then traverses the ray tracing acceleration data. Thus, the ray tracing acceleration data structure generating circuit may be (part of) the graphics processor. Alternatively, a (the) ray tracing acceleration data structure may be generated by a different data processor to the graphics processor that traverses the ray tracing acceleration data. For example, a ray tracing acceleration data structure may be generated a host processor, e.g. CPU, or another processor, of a data processing system. Thus, the ray tracing acceleration data structure generating circuit may be (part of) another data processor of a data processing system, e.g. a CPU.

It would be possible for the geometry data stored for a (e.g. end/leaf) node associated with a bounding volume primitive to comprise data indicating vertex positions of the bounding volume primitive, e.g. as discussed above for polygons. However, since in embodiments of the technology described herein, ray-bounding volume primitive intersection tests are not performed, the storing of such data is not necessary. Thus, in embodiments, the geometry data stored for a (each) (e.g. end/leaf) node associated with a bounding volume primitive does not comprise any data indicating vertex positions of the bounding volume primitive.

In embodiments, the geometry data stored for a (each) (e.g. end/leaf) node associated with a bounding volume primitive comprises (only) data that can be (and in embodiments is) used (by the graphics processor) to determine how to further process geometry (e.g. how to process further geometry, e.g. a procedural object, defined within the bounding volume primitive). For example, in embodiments, the geometry data stored for a (each) (e.g. end/leaf) node associated with a bounding volume primitive comprises (only) data indicating a material that the bounding volume primitive/further geometry/procedural object represents. In embodiments, the data indicating a material is stored in the same/corresponding field of the predefined data structure as is used to store data indicating a material in the case of polygon geometry data.

Accordingly, in embodiments, the amount of useful data stored for a (each) (e.g. end/leaf) node associated with a bounding volume primitive is (much) less than the amount of useful data stored for a (each) (e.g. end/leaf) node associated with one or more polygons (e.g. (three) triangle primitives). That is, in embodiments, not all of (only some but not all of) the date fields/elements in the predefined data structure that is used for storing polygon nodes will be populated with “useful” data when using the data structure for storing a bounding volume primitive node. Correspondingly, the predefined data structure will be (much) more sparsely populated when being used for storing a bounding volume node as compared with when the predefined data structure is being used for storing for a polygon node.

In this regard, the inventors have realised that even though storing polygon geometry data and bounding volume/procedural object geometry data in the same predefined data structure using the same amount of storage space may result in a relatively large amount of “empty” storage space being used for bounding volume/procedural object geometry data, this may be outweighed by the advantages e.g. of reduced circuit complexity, area requirements and energy consumption, associated with this arrangement.

Each embodiment can, and in embodiments does, include one or more, and in embodiments all, features of other embodiments of the technology described herein, as appropriate.

The technology described herein can be implemented in any suitable system, such as a suitably configured micro-processor based system. In embodiments, the technology described herein is implemented in a computer and/or micro-processor based system. The technology described herein is in embodiments implemented in a portable device, such as, and in embodiments, a mobile phone or tablet.

The technology described herein is applicable to any suitable form or configuration of graphics processor and graphics processing system, such as graphics processors (and systems) having a “pipelined” arrangement (in which case the graphics processor executes a rendering pipeline).

In embodiments, the various functions of the technology described herein are carried out on a single data processing platform that generates and outputs data, for example for a display device.

As will be appreciated by those skilled in the art, the data/graphics processing system may include, e.g., and in embodiments, a host processor that, e.g., executes applications that require processing by the graphics processor. The host processor will send appropriate commands and data to the graphics processor to control it to perform graphics processing operations and to produce graphics processing output required by applications executing on the host processor. To facilitate this, the host processor should, and in embodiments does, also execute a driver for the processor and optionally a compiler or compilers for compiling (e.g. shader) programs to be executed by (e.g. an (programmable) execution unit of) the processor.

The processor may also comprise, and/or be in communication with, one or more memories and/or memory devices that store the data described herein, and/or store software (e.g. (shader) program) for performing the processes described herein. The processor may also be in communication with a host microprocessor, and/or with a display for displaying images based on data generated by the processor.

The technology described herein can be used for all forms of input and/or output that a graphics processor may use or generate. For example, the graphics processor may execute a graphics processing pipeline that generates frames for display, render-to-texture outputs, etc., The output data values from the processing are in embodiments exported to external, e.g. main, memory, for storage and use, such as to a frame buffer for a display.

The various functions of the technology described herein can be carried out in any desired and suitable manner. For example, the functions of the technology described herein can be implemented in hardware or software, as desired. Thus, for example, the various functional elements, stages, and “means” of the technology described herein may comprise a suitable processor or processors, controller or controllers, functional units, circuitry, circuit(s), processing logic, microprocessor arrangements, etc., that are operable to perform the various functions, etc., such as appropriately dedicated hardware elements (processing circuit(s)) and/or programmable hardware elements (processing circuit(s)) that can be programmed to operate in the desired manner.

It should also be noted here that, as will be appreciated by those skilled in the art, the various functions, etc., of the technology described herein may be duplicated and/or carried out in parallel on a given processor. Equally, the various processing stages may share processing circuit(s), etc., if desired.

Furthermore, any one or more or all of the processing stages of the technology described herein may be embodied as processing stage circuitry/circuits, e.g., in the form of one or more fixed-function units (hardware) (processing circuitry/circuits), and/or in the form of programmable processing circuitry/circuits that can be programmed to perform the desired operation. Equally, any one or more of the processing stages and processing stage circuitry/circuits of the technology described herein may be provided as a separate circuit element to any one or more of the other processing stages or processing stage circuitry/circuits, and/or any one or more or all of the processing stages and processing stage circuitry/circuits may be at least partially formed of shared processing circuitry/circuits.

Subject to any hardware necessary to carry out the specific functions discussed above, the components of the data processing system can otherwise include any one or more or all of the usual functional units, etc., that such components include.

It will also be appreciated by those skilled in the art that all of the described embodiments of the technology described herein can include, as appropriate, any one or more or all of the optional features described herein.

The methods in accordance with the technology described herein may be implemented at least partially using software e.g. computer programs. It will thus be seen that when viewed from further embodiments the technology described herein provides computer software specifically adapted to carry out the methods herein described when installed on a data processor, a computer program element comprising computer software code portions for performing the methods herein described when the program element is run on a data processor, and a computer program comprising code adapted to perform all the steps of a method or of the methods herein described when the program is run on a data processing system. The data processing system may be a microprocessor, a programmable FPGA (Field Programmable Gate Array), etc.

The technology described herein also extends to a computer software carrier comprising such software which when used to operate a data processor, renderer or other system comprising a data processor causes in conjunction with said data processor said processor, renderer or system to carry out the steps of the methods of the technology described herein. Such a computer software carrier could be a physical storage medium such as a ROM chip, CD ROM, RAM, flash memory, or disk, or could be a signal such as an electronic signal over wires, an optical signal or a radio signal such as to a satellite or the like.

It will further be appreciated that not all steps of the methods of the technology described herein need be carried out by computer software and thus from a further broad embodiment the technology described herein provides computer software and such software installed on a computer software carrier for carrying out at least one of the steps of the methods set out herein.

The technology described herein may accordingly suitably be embodied as a computer program product for use with a computer system. Such an implementation may comprise a series of computer readable instructions fixed on a tangible, non-transitory medium, such as a computer readable medium, for example, diskette, CD ROM, ROM, RAM, flash memory, or hard disk. It could also comprise a series of computer readable instructions transmittable to a computer system, via a modem or other interface device, over either a tangible medium, including but not limited to optical or analogue communications lines, or intangibly using wireless techniques, including but not limited to microwave, infrared or other transmission techniques. The series of computer readable instructions embodies all or part of the functionality previously described herein.

Those skilled in the art will appreciate that such computer readable instructions can be written in a number of programming languages for use with many computer architectures or operating systems. Further, such instructions may be stored using any memory technology, present or future, including but not limited to, semiconductor, magnetic, or optical, or transmitted using any communications technology, present or future, including but not limited to optical, infrared, or microwave. It is contemplated that such a computer program product may be distributed as a removable medium with accompanying printed or electronic documentation, for example, shrink wrapped software, pre-loaded with a computer system, for example, on a system ROM or fixed disk, or distributed from a server or electronic bulletin board over a network, for example, the Internet or World Wide Web.

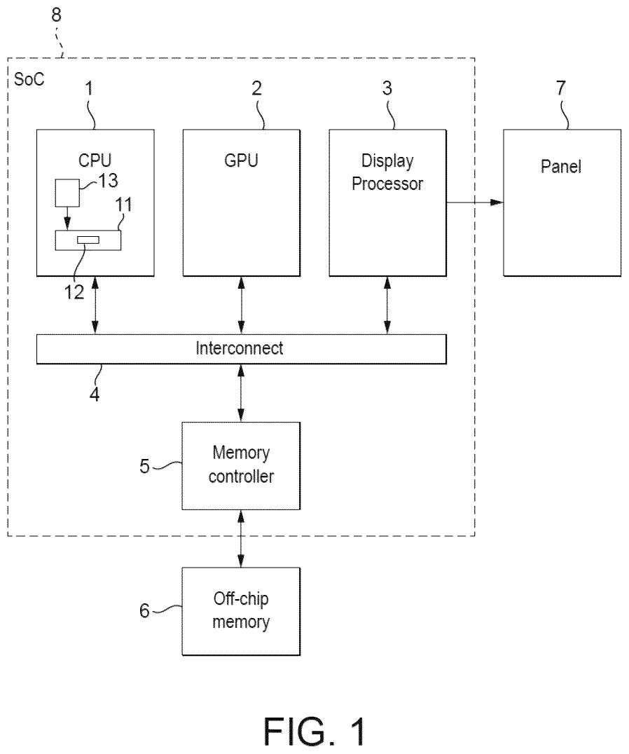

The present embodiments relate to the operation of a graphics processor, e.g. in a graphics processing system as illustrated in FIG. 1, when performing rendering of a scene to be displayed using a ray tracing based rendering process.

Ray tracing is a rendering process which involves tracing the paths of rays of light from a viewpoint (sometimes referred to as a “camera”) back through sampling positions in an image plane (which is the frame being rendered) into a scene, and simulating the effect of the interaction between the rays and objects in the scene. The output data value e.g. colour of a sampling position in the image is determined based on the object(s) in the scene intersected by the ray passing through the sampling position, and the properties of the surfaces of those objects. The ray tracing process thus involves determining, for each sampling position, a set of objects within the scene which a ray passing through the sampling position intersects.

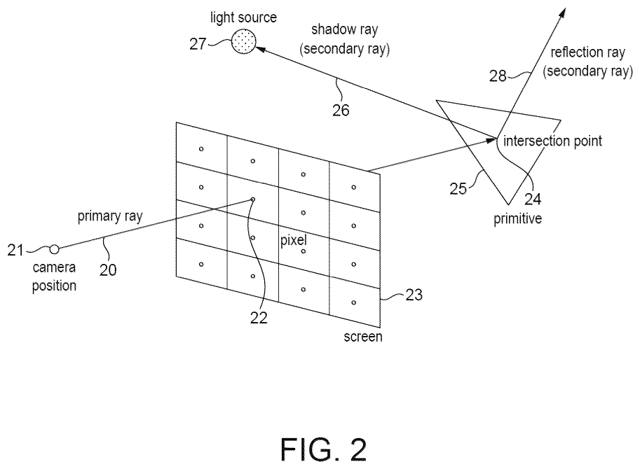

FIG. 2 illustrates an exemplary “full” ray tracing process. A ray 20 (the “primary ray”) is cast backward from a viewpoint 21 (e.g. camera position) through a sampling position 22 in an image plane (frame) 23 into the scene that is being rendered. The point 24 at which the ray 20 first intersects an object, which in this case is represented by a triangle primitive 25, in the scene is identified. This first intersection will be with the object in the scene closest to the sampling position.

A secondary ray in the form of shadow ray 26 may be cast from the first intersection point 24 to a light source 27. Depending upon the material of the surface of the object, another secondary ray in the form of reflected ray 28 may be traced from the intersection point 24. If the object is, at least to some degree, transparent, then a refracted secondary ray may be considered.

Such casting of secondary rays may be used where it is desired to add shadows and reflections into the image. A secondary ray may be cast in the direction of each light source (and, depending upon whether or not the light source is a point source, more than one secondary ray may be cast back to a point on the light source).

In the example shown in FIG. 2, only a single bounce of the primary ray 20 is considered, before tracing the reflected ray back to the light source. However, a higher number of bounces may be considered if desired.

The output data for the sampling position 22 i.e. a colour value (e.g. RGB value) thereof, is then determined taking into account the interactions of the primary, and any secondary, ray(s) cast, with objects in the scene. The same process is conducted in respect of each sampling position to be considered in the image plane (frame) 23.

In order to facilitate such ray tracing processing, in the present embodiments acceleration data structures indicative of the geometry (e.g. objects) in scenes to be rendered are used when determining the intersection data for the ray(s) associated with a sampling position in the image plane to identify a subset of the geometry which a ray may intersect.

The ray tracing acceleration data structure represents and indicates the distribution of geometry (e.g. objects) in the scene being rendered, and in particular the geometry that falls within respective (sub-) volumes in the overall volume of the scene (that is being considered).

In the present embodiments, a ray tracing acceleration data structure is in the form of one or more Bounding Volume Hierarchy (BVH) trees. The use of BVH trees allows and facilitates testing a ray against a hierarchy of bounding volumes until a leaf node is found. It is then only necessary to test the geometry associated with the particular leaf node for intersection with the ray.

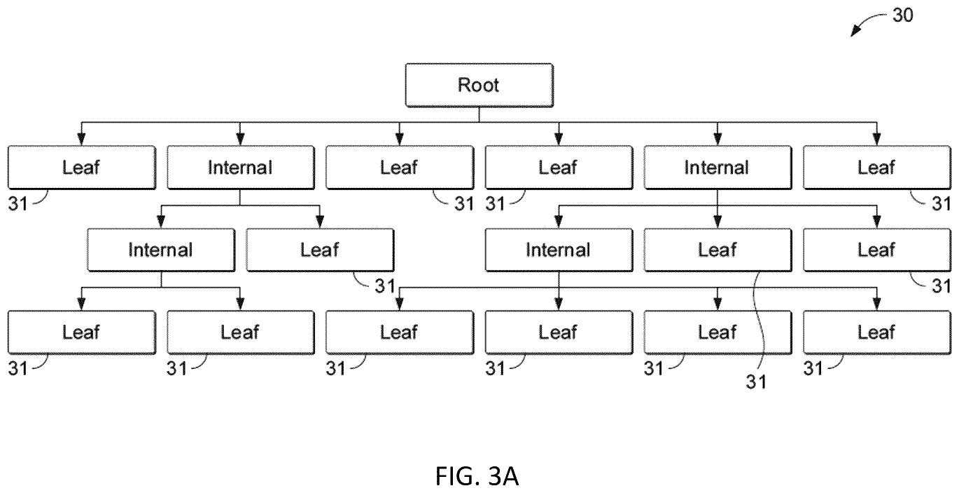

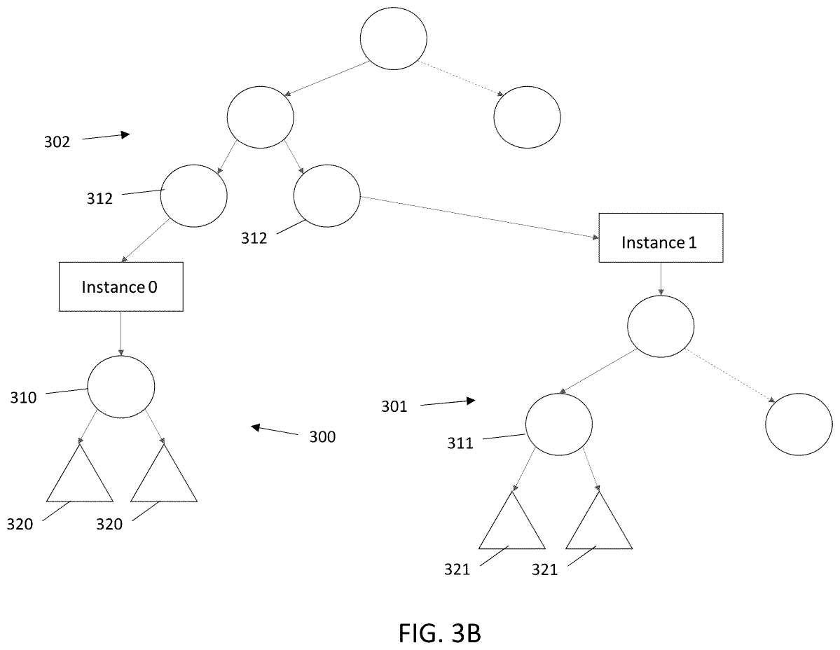

FIG. 3A shows an exemplary BVH tree 30, constructed by enclosing a volume in an axis-aligned bounding volume (AABV), e.g. a cube, and then recursively subdividing the bounding volume into successive sub-AABVs according to any suitable and desired subdivision scheme, until a desired smallest subdivision (volume) is reached.

In this example, the BVH tree 30 is a relatively “wide” tree wherein each bounding volume is subdivided into up to six sub-AABVs. However, in general, any other suitable tree structure may be used, and a given node of the tree may have any suitable and desired number of child nodes.

Thus, each node in the BVH tree 30 will have a respective volume associated with it, with the end, leaf nodes 31 each representing a particular smallest subdivided volume, and any parent node representing, and being associated with, the volume of its child nodes.

A complete scene may be represented by a single BVH tree, e.g. with the tree storing the geometry for the scene in world space. In this case, each leaf node of the BVH tree 30 may be associated with the geometry defined for the scene that falls, at least in part, within the volume that the leaf node corresponds to (e.g. whose centroid falls within the volume in question). The leaf nodes 31 may represent unique (non-overlapping) subsets of primitives defined for the scene falling within the corresponding volumes for the leaf nodes 31.

In the present embodiments, a two-level ray tracing acceleration data structure is used. FIG. 3B shows an exemplary two-level ray tracing acceleration data structure in which each instance or object is associated with a respective bottom-level acceleration structure (BLAS) 300, 301, which in the present embodiments is in the form of a respective BVH tree that stores geometry in model space, with each leaf node 310, 311 of the BVH tree representing a unique subset of primitives 320, 321 defined for the instance or object falling within the corresponding volume.

A separate top-level acceleration structure (TLAS) 302 then contains references to the set of bottom-level acceleration structures (BLAS), together with a respective set of shading and transformation information for each bottom-level acceleration structure (BLAS). In the present embodiments, the top-level acceleration structure (TLAS) 302 is defined in world space and is in the form of a BVH tree having leaf nodes 312 that each point to one or more of the bottom-level acceleration structures (BLAS) 300, 301.

Other forms of ray tracing acceleration data structure would be possible.

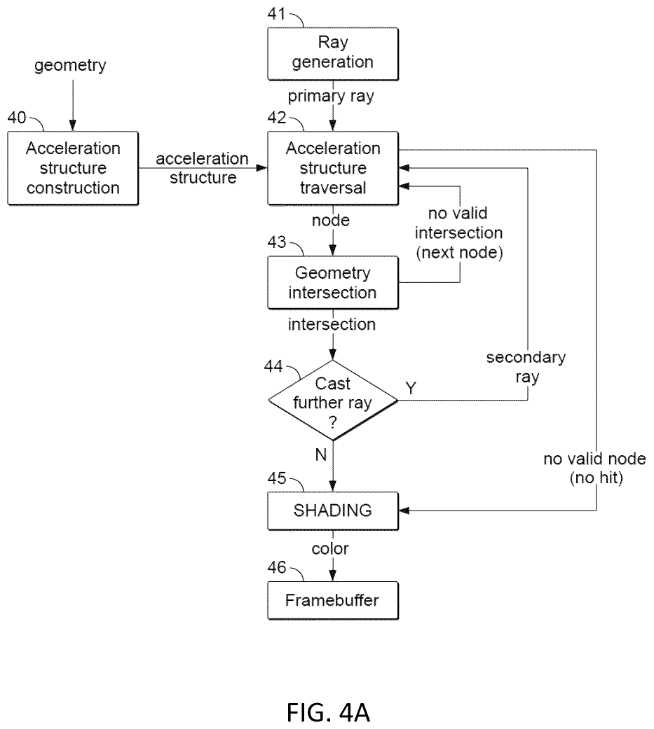

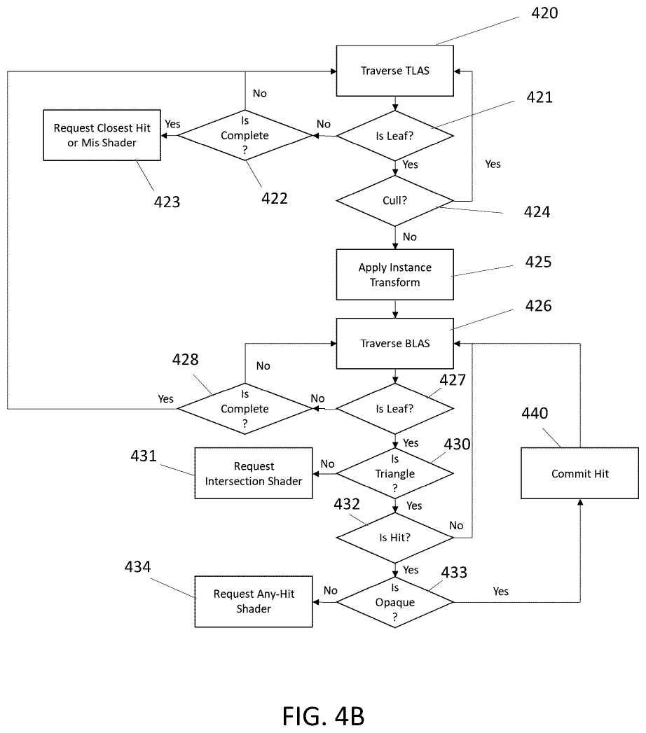

FIG. 4A is a flow chart showing an overall ray tracing process that may be performed on and by the graphics processor 2.

First, the geometry of the scene is analysed and used to obtain an acceleration data structure (step 40), for example in the form of one or more BVH tree structures, as discussed above. This can be done in any suitable and desired manner, for example by means of an initial processing pass on the graphics processor 2.

A primary ray is then generated, passing from a camera through a particular sampling position in an image plane (frame) (step 41). The acceleration data structure is then traversed for the primary ray (step 42), and the leaf node corresponding to the first volume that the ray passes through which contains geometry which the ray potentially intersects is identified. It is then determined whether the ray intersects any of the geometry, e.g. primitives, (if any) in that leaf node (step 43).

If no (valid) geometry which the ray intersects can be identified in the node, the process returns to step 42, and the ray continues to traverse the acceleration data structure and the leaf node for the next volume that the ray passes through which may contain geometry with which the ray intersects is identified, and a test for intersection performed at step 43.

This is repeated for each leaf node that the ray (potentially) intersects, until geometry that the ray intersects is identified.

When geometry that the ray intersects is identified, it is then determined whether to cast any further (secondary) rays for the primary ray (and thus sampling position) in question (step 44). This may be based, e.g., and in an embodiment, on the nature of the geometry (e.g. its surface properties) that the ray has been found to intersect, and the complexity of the ray tracing process being used.

Thus, as shown in FIG. 4A, one or more secondary rays may be generated emanating from the intersection point (e.g. a shadow ray(s), a refraction ray(s) and/or a reflection ray(s), etc.). Steps 42, 43 and 44 are then performed in relation to each secondary ray.

Once there are no further rays to be cast, a shaded colour for the sampling position that the ray(s) correspond to is then determined based on the result(s) of the casting of the primary ray, and any secondary rays considered (step 45), taking into account the properties of the surface of the object at the primary intersection point, any geometry intersected by secondary rays, etc., The shaded colour for the sampling position is then stored in the frame buffer (step 46).

If no (valid) node which may include geometry intersected by a given ray (whether primary or secondary) can be identified in step 42 (and there are no further rays to be cast for the sampling position), the process moves to step 45, and shading is performed. In this case, the shading is in an embodiment based on some form of “default” shading operation that is to be performed in the case that no intersected geometry is found for a ray. This could comprise, e.g., simply allocating a default colour to the sampling position, and/or having a defined, default geometry to be used in the case where no actual geometry intersection in the scene is found, with the sampling position then being shaded in accordance with that default geometry. Other arrangements are possible.

This process is performed for each sampling position to be considered in the image plane (frame). Once the final output value for the sampling position in question has been generated, the processing in respect of that sampling position is completed. A next sampling position may then be processed in a similar manner, and so on, until all the sampling positions for the frame have been appropriately shaded. The frame may then be output, e.g. for display, and the next frame to be rendered processed in a similar manner, and so on.

FIG. 4B is a flow chart showing in more detail acceleration structure traversal in the case of a two-level acceleration data structure, e.g. as described above with reference to FIG. 3B. As shown in FIG. 4B, in this case, acceleration structure traversal begins with TLAS traversal (step 420), and TLAS traversal continues in search of a TLAS leaf node (steps 421, 422). If no TLAS leaf node can be identified, a “default” shading operation (“miss shader”) may be performed (step 423), e.g. as described above.

When (at step 421) a TLAS leaf node is identified, it is determined whether that leaf node can be culled from further processing (step 424). If it can be culled from further processing, the process returns to TLAS traversal (step 420).

If the TLAS leaf node cannot be culled from further processing, instance transform information associated with the leaf node is used to transform the ray to the appropriate space for BLAS traversal (step 425). BLAS traversal then begins (step 426), and continues in search of a BLAS leaf node (steps 427, 428). If no BLAS leaf node can be identified, the process may return to TLAS traversal (step 420).

In the present embodiments, geometry associated with a BLAS leaf node can be in the form of a set of triangle primitives or an axis aligned bounding box (AABB) primitive. When (at step 427) a BLAS leaf node is identified, it is determined whether geometry associated with the leaf node is in the form of a set of triangle primitives or an axis aligned bounding box (AABB) primitive (step 430). As shown in FIG. 4B, when an axis aligned bounding box (AABB) primitive is encountered, execution of a shader program (“intersection shader”) that defines a procedural object encompassed by the axis aligned bounding box (AABB) is triggered (step 431) to determine whether a ray intersects the procedural object defined by the shader program. On the other hand, when a set of triangle primitives is encountered, determining whether a ray intersects any of the triangle primitives is performed by fixed function circuitry (step 432) (as will be discussed further below).

If no (valid) triangle primitives which the ray intersects can be identified in the node, the process returns to BLAS traversal (step 426). If a ray is found to intersect a triangle primitive, it is determined whether or not the triangle primitive is opaque (step 433). In the case of the triangle primitive being found to be non-opaque, execution of an appropriate shader program (“any-hit shader”) may be triggered (step 434). Otherwise, in the case of the triangle primitive being found to be opaque, the intersection can be committed without executing a shader program (step 440). Traversal for one or more secondary rays may be triggered, as appropriate, e.g. as discussed above.

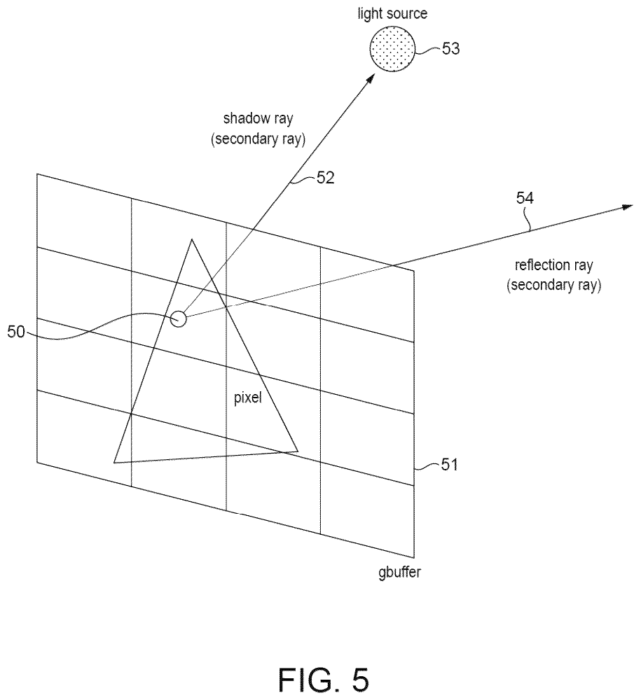

FIG. 5 shows an alternative ray tracing process which may be used in embodiments of the technology described herein, in which only some of the steps of the full ray tracing process described above are performed. Such an alternative ray tracing process may be referred to as a “hybrid” ray tracing process.

In this process, as shown in FIG. 5, the first intersection point 50 for each sampling position in the image plane (frame) is instead determined first using a rasterisation process and stored in an intermediate data structure known as a “G-buffer” 51. Thus, the process of generating a primary ray for each sampling position, and identifying the first intersection point of the primary ray with geometry in the scene, is replaced with an initial rasterisation process to generate the “G-buffer”. The G-buffer includes information indicative of the depth, colour, normal and surface properties (and any other appropriate and desired data, e.g. albedo, etc.) for each first (closest) intersection point for each sampling position in the image plane (frame).

Secondary rays, e.g. shadow ray 52 to light source 53, and reflection ray 54, may then be cast starting from the first intersection point 50, and the shading of the sampling positions determined based on the properties of the geometry first intersected, and the interactions of the secondary rays with geometry in the scene.

Referring to the flowchart of FIG. 4A, in such a hybrid process, the initial pass of steps 41, 42 and 43 of the full ray tracing process for a primary ray will be omitted, as there is no need to cast primary rays and determine their first intersection with geometry in the scene. The first intersection point data for each sampling position is instead obtained from the G-buffer.

The process may then proceed to the shading stage 45 based on the first intersection point for each pixel obtained from the G-buffer, or where secondary rays emanating from the first intersection point are to be considered, these will need to be cast in the manner described by reference to FIG. 4. Thus, steps 42, 43 and 44 will be performed in the same manner as previously described in relation to the full ray tracing process for any secondary rays.

The colour determined for a sampling position will be written to the frame buffer in the same manner as step 46 of FIG. 4A, based on the shading colour determined for the sampling position based on the first intersection point (as obtained from the G-buffer), and, where applicable, the intersections of any secondary rays with objects in the scene, determined using ray tracing.

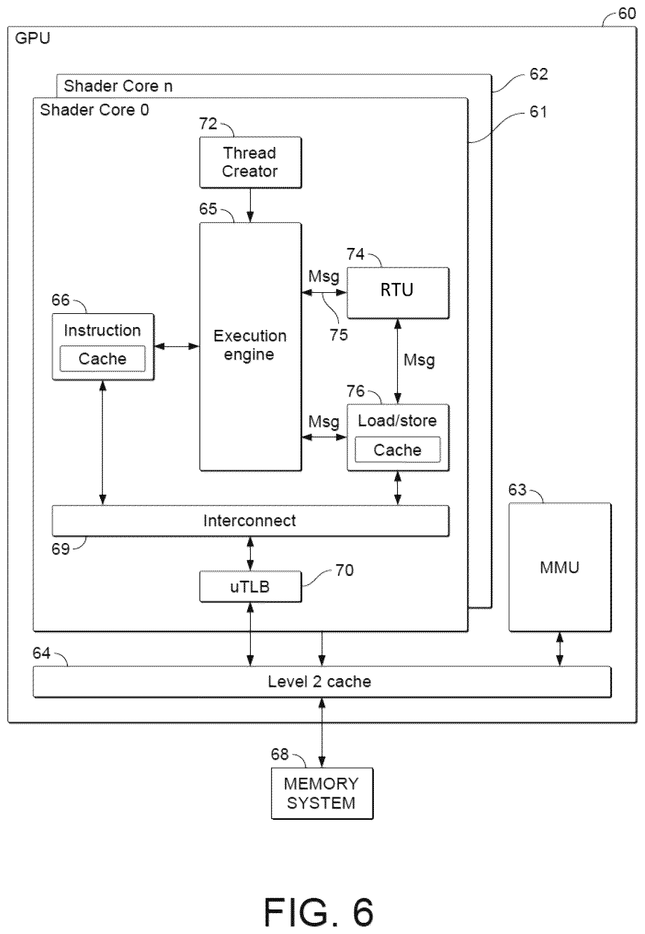

FIG. 6 shows schematically the relevant elements and components of a graphics processor (GPU) 2, 60 of the present embodiments.

As shown in FIG. 6, the GPU 60 includes one or more shader (processing) cores 61, 62 together with a memory management unit (“MMU”) 63 and a level 2 cache 64 which is operable to communicate with an off-chip memory system 68 (e.g. via an appropriate interconnect and (dynamic) memory controller).

FIG. 6 shows schematically the relevant configuration of one shader core 61, but as will be appreciated by those skilled in the art, any further shader cores of the graphics processor 60 will be configured in a corresponding manner.

The graphics processor (GPU) shader cores 61, 62 are programmable processing units (circuits) that perform processing operations by running small programs for each “item” in an output to be generated such as a render target, e.g. frame. An “item” in this regard may be, e.g. a vertex, one or more sampling positions, etc., The shader cores will process each “item” by means of one or more execution threads which will execute the instructions of the shader program(s) in question for the “item” in question. Typically, there will be multiple execution threads each executing at the same time (in parallel).

FIG. 6 shows the main elements of the graphics processor 60 that are relevant to the operation of the present embodiments. As will be appreciated by those skilled in the art there may be other elements of the graphics processor 60 that are not illustrated in FIG. 6. It should also be noted here that FIG. 6 is only schematic, and that, for example, in practice the shown functional units may share significant hardware circuits, even though they are shown schematically as separate units in FIG. 6. It will also be appreciated that each of the elements and units, etc., of the graphics processor as shown in FIG. 6 may, unless otherwise indicated, be implemented as desired and will accordingly comprise, e.g., appropriate circuits (processing logic), etc., for performing the necessary operation and functions.

As shown in FIG. 6, each shader core of the graphics processor 60 includes an appropriate programmable execution unit (execution engine) 65 that is operable to execute graphics shader programs for execution threads to perform graphics processing operations.

The shader core 61 also includes an instruction cache 66 that stores instructions to be executed by the programmable execution unit 65 to perform graphics processing operations. The instructions to be executed will, as shown in FIG. 6, be fetched from the memory system 68 via an interconnect 69 and a micro-TLB (translation lookaside buffer) 70.

The shader core 61 also includes an appropriate load/store unit 76 in communication with the programmable execution unit 65, that is operable, e.g., to load into an appropriate cache, data, etc., to be processed by the programmable execution unit 65, and to write data back to the memory system 68 (for data loads and stores for programs executed in the programmable execution unit). Again, such data will be fetched/stored by the load/store unit 76 via the interconnect 69 and the micro-TLB 70.

In order to perform graphics processing operations, the programmable execution unit 65 will execute graphics shader programs (sequences of instructions) for respective execution threads (e.g. corresponding to respective sampling positions of a frame to be rendered).

Accordingly, as shown in FIG. 6, the shader core 61 further comprises a thread creator (generator) 72 operable to generate execution threads for execution by the programmable execution unit 65.

The ray tracing traversal operation may be performed for a group of plural rays together, e.g. substantially as described in US 2022/0392147. This can allow processing resources for groups of rays to be shared.

A ray tracing traversal program may thus be executed by a group (“warp”) of plural execution threads, with each ray in the group of plural rays being processed by a corresponding execution thread in a group of plural execution threads that are executing the program at the same time. The thread creator (generator) 72 may thus generate groups (“warps”) of plural execution threads, and the programmable execution unit 65 may execute shader programs for a group (“warp”) of plural execution threads together, e.g. in lockstep, e.g., one instruction at a time.

In the present embodiments, each group of rays includes 32 rays (and correspondingly each group (“warp”) of execution threads includes 32 threads), but other numbers are possible.

As shown in FIG. 6, the shader core 61 in this embodiment also includes a ray tracing circuit (unit) (“RTU”) 74, which is in communication with the programmable execution unit 65, and which is operable to perform the required ray-volume testing during the ray tracing acceleration data structure traversals (e.g. the operation of steps 420 and 426 of FIG. 4B) for rays being processed as part of a ray tracing-based rendering process, in response to messages 75 received from the programmable execution unit 65. In the present embodiments the RTU 74 is also operable to perform the required ray-triangle testing (e.g. the operation of step 432 of FIG. 4B).

The RTU 74 is also able to communicate with the load/store unit 76 for loading in the required data for such intersection testing.

In the present embodiments, the RTU 74 of the graphics processor is a (substantially) fixed-function hardware unit (circuit) that is configured to perform the required ray-volume and ray-triangle intersection testing during a traversal of a ray tracing acceleration data structure to determine geometry for a scene to be rendered that may be (and is) intersected by a ray being used for a ray tracing operation. However, some amount of configurability may be provided. Other arrangements would be possible. For example, ray-volume and/or ray-triangle intersection testing may be performed by the programmable execution unit 65 (e.g. in software).

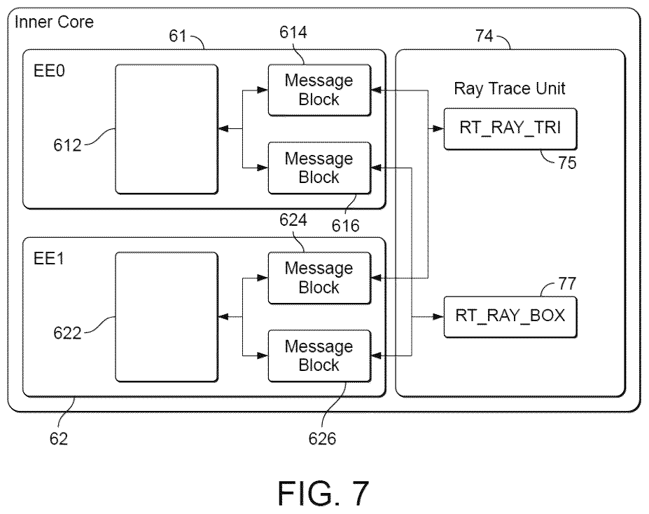

FIG. 7 shows in more detail the communication between the RTU 74 and the shader cores 61, 62, in the present embodiments. As shown in FIG. 7, in the present embodiments, the RTU 74 includes respective hardware circuits for performing the ray-volume testing (RT_RAY_BOX) 77 and for performing the ray-triangle testing (RT_RAY_TRI) 75. The shader cores 61, 62 thus contain appropriate message blocks 614, 616, 624, 626 for messaging the respective ray-volume testing circuit 77 and ray-triangle testing circuit 75 accordingly when it is desired to perform intersection testing during a traversal operation.

In the present embodiments, execution of an appropriate ray-volume testing instruction (′RT_RAY_BOX′) included in a shader program triggers the execution unit 65 to message the ray-volume intersection testing circuit 77 of the RTU 74 to perform the desired ray-volume testing. Similarly, execution of an appropriate instruction (′RT_RAY_TRI′) included in a shader program triggers the execution unit to message the ray-triangle intersection testing circuit 75 of the RTU 74 to perform the desired ray-triangle testing.

As shown in FIG. 7, the message blocks communicate with respective local storage 612, 622 of the shader cores 61, 62 so that the result of the intersection testing can be stored locally.

The traversal operation may be managed for a group of plural rays together or separately using a traversal stack that is maintained in the local storage 612, 622. The local storage 612, 622 can comprise any suitable and desired type of storage, such as registers, RAM, etc.

A traversal stack includes stack entries that each indicate a node to be visited and tested, with the top entry in the stack indicating the next node to be visited and tested for a ray. The top entry in the stack is accordingly popped to determine the next node to visit and test, and when it is determined that a new node should be visited and tested, a corresponding stack entry is pushed to the stack.

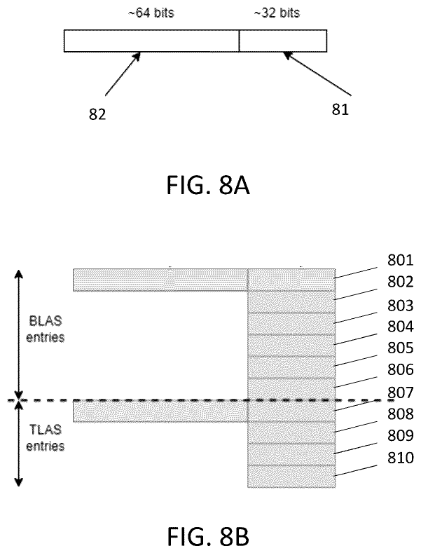

FIG. 8A illustrates an exemplary stack entry, according to embodiments. As shown in FIG. 8A, in the present embodiments, each stack entry includes node information 81 that includes information indicating a volume associated with a node to be tested and any child nodes that are associated with the node. A stack entry that relates to a leaf node further includes leaf information 82 that may indicate geometry represented by the leaf node in question (e.g. in the case of a BLAS leaf node) or references to one or more other (e.g. BLAS) acceleration structures together with shading and transformation information (e.g. in the case of a TLAS leaf node).

As shown in FIG. 8A, in the present embodiments the node information 81 comprises 32 bits, and the leaf information 82 comprises 64 bits. A leaf node stack entry thus comprises 96 bits, whereas an internal node stack entry comprises only 32 bits. Other arrangements are possible.

FIG. 8B illustrates an exemplary stack of entries to be processed by a shader core 61, 62. As shown in FIG. 8B, in this example, the stack includes six stack entries 801-806 for BLAS nodes at the top of the stack, and four stack entries 807-810 for TLAS nodes at the bottom of the stack.

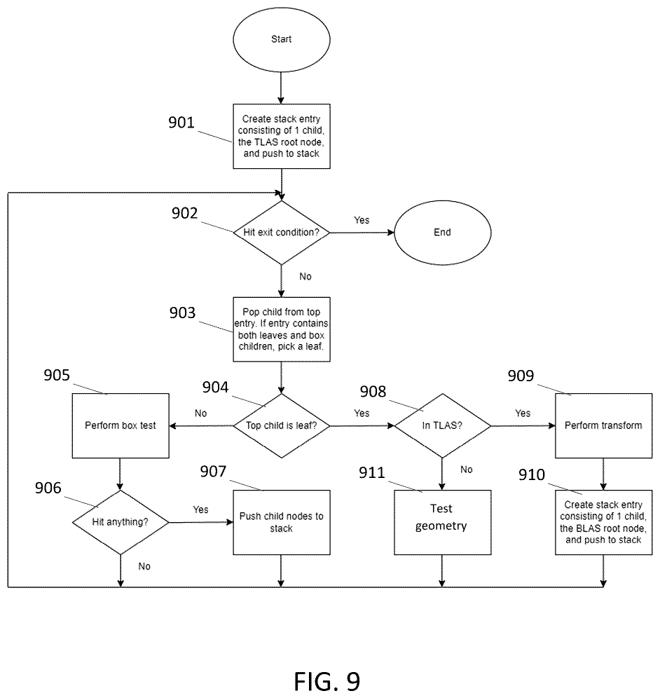

FIG. 9 is a flowchart showing the operation of a shader core 61, 62 of the graphics processor 2, 60 when performing a ray tracing-based rendering process. FIG. 9 shows the operation in respect of a given ray, and this operation will be performed for each ray being traced.

As shown in FIG. 9, the process begins with a first entry being pushed to the stack corresponding to the TLAS root node (step 901). There is then a check to determine whether tracing for the current ray is complete (step 902), and if not, the process continues with the top entry in the stack being popped (step 903) for processing.

As the TLAS root node should be an internal node (i.e. not a leaf node) (at step 904), it is subjected to a ray-volume intersection test (at step 905), and for any child nodes determined to be intersected (at step 906), a corresponding stack entry is pushed to the stack (at step 907). The process then returns to step 902 to determine whether tracing for the current ray is complete, and if not, the process continues with the top entry in the stack being popped (step 903) for processing.

As shown in FIG. 9, when a TLAS leaf node is reached (step 908), transformation information associated with the leaf node is used to transform the ray (step 909), and a stack entry corresponding to a BLAS root node is pushed to the stack (step 910). The process then returns to step 902 to determine whether tracing for the current ray is complete, and if not, the process continues with the top entry in the stack being popped (step 903) for processing.

As a BLAS root node should be an internal node (i.e. not a leaf node) (at step 904), it is subjected to a ray-volume intersection test (at step 905), and for any child nodes determined to be intersected (at step 906), a corresponding stack entry is pushed to the stack (step 907). The process then returns to step 902 to determine whether tracing for the current ray is complete, and if not, the process continues with the top entry in the stack being popped (step 903) for processing.

As shown in FIG. 9, when a BLAS leaf node is reached (step 908), the geometry associated with the leaf node is tested for intersection (at step 911). The process then returns to step 902 to determine whether tracing for the current ray is complete, and if not, the process continues with the top entry in the stack being popped (step 903) for processing.

As discussed above, with reference to FIG. 4B, the manner in which geometry testing of step 911 is performed can depend on the type of geometry being tested. For example, in the case of a triangle primitive, the ray-triangle intersection testing circuit 75 is triggered to perform a ray-triangle intersection test. In the case of an axis aligned bounding box (AABB) primitive, execution by a shader core 61, 62 of an “intersection shader” that defines a procedural object to be tested may be triggered.

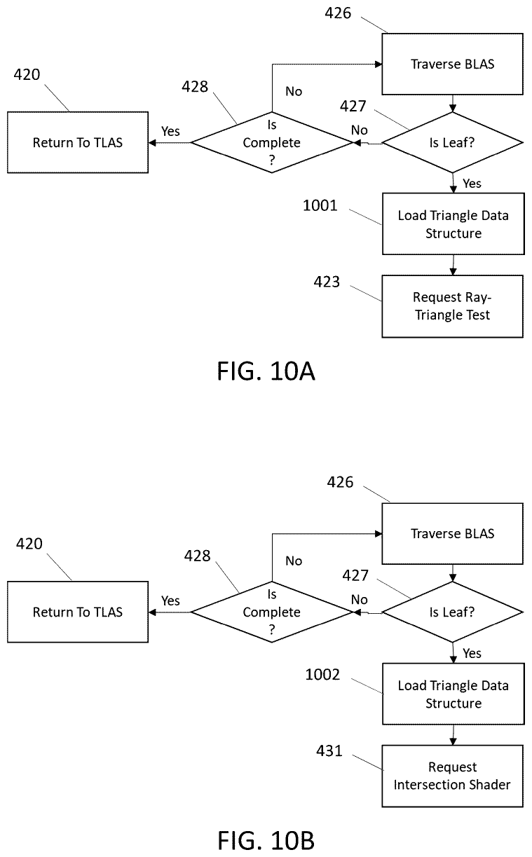

FIG. 10A is a flow diagram showing in more detail the BLAS traversal and intersection testing operations in the case of a triangle primitive. FIG. 10A illustrates BLAS traversal being performed in search of a leaf node (steps 426, 427, 428). If no BLAS leaf node can be identified, the process may return to TLAS traversal (step 420).

When (at step 427) a BLAS leaf node is identified, a request for the triangle primitive data that is required to perform ray-triangle intersection testing is issued (at step 1001) to the load/store unit 76. If the data is already present locally, e.g. within a cache, it can be fetched from that location accordingly. On the other hand, if the data is not present locally, it must be obtained from memory.

In the present embodiments, triangle primitive data is stored to facilitate efficient memory access. For example, the main (e.g. off-chip) memory 6, 68 may be configured to access data in fixed bursts/blocks of data, for example 64-byte naturally aligned blocks of data, to maximise memory access efficiency. The graphics processor cache memory, and cache line size is similarly arranged to fetch blocks of data in this manner. In the present embodiments, primitive data is accordingly stored in data structures that are aligned with the size of the cache lines and memory transactions (i.e. 64 bytes).

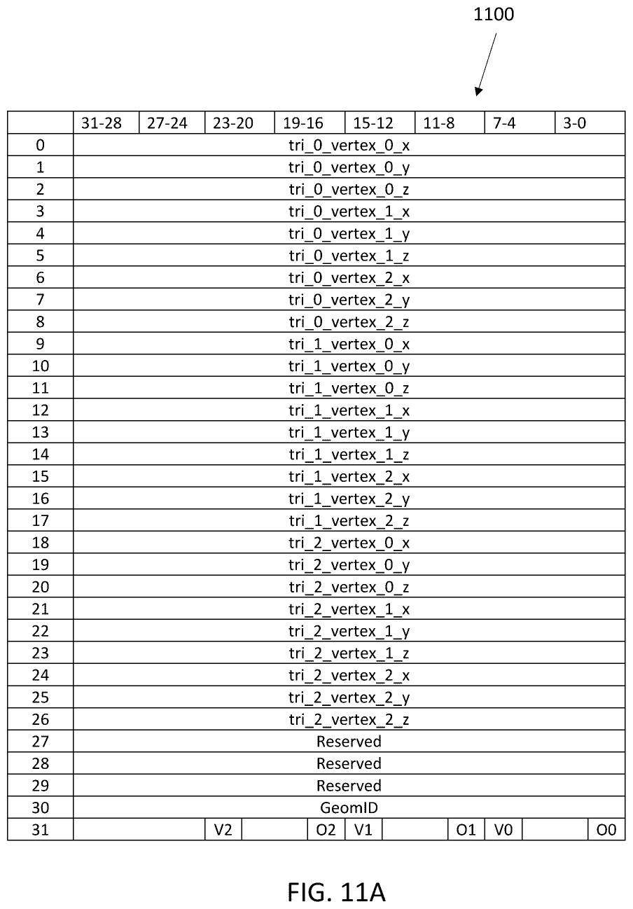

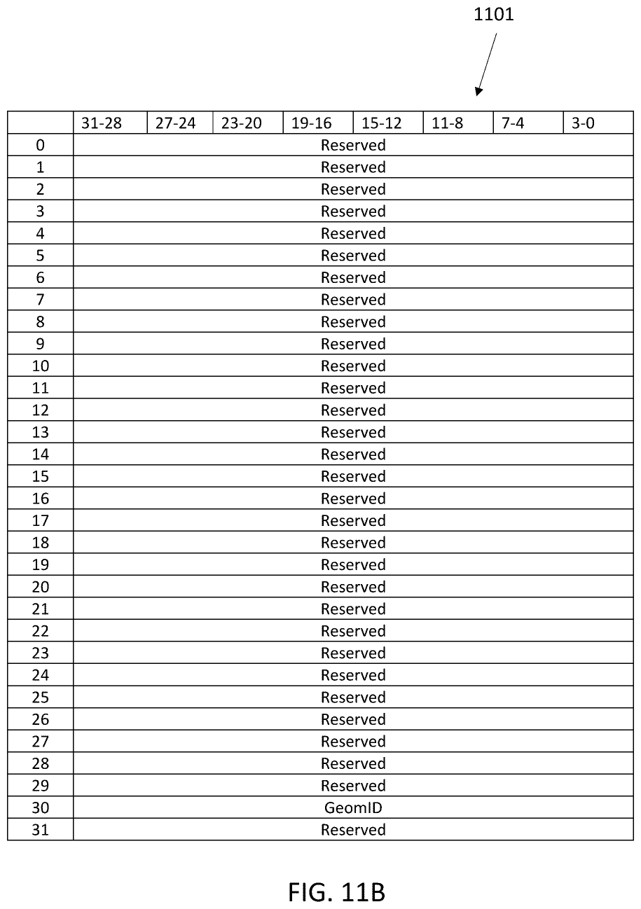

FIG. 11A shows an example of a data structure 1100 for storing triangle primitive data for use in a ray-triangle intersection test, according to the present embodiments. The data structure shown in FIG. 11A is a 128-byte data structure comprising 32 lines each capable of storing 32 bits. This data structure can therefore fit within two 64-byte cache lines.

In the present embodiments, a BLAS leaf node can comprise (up to) three triangle primitives. Each triangle comprises three vertices, with three co-ordinates (x,y,z) being stored for each vertex. As shown in FIG. 11A, in this embodiment, each vertex co-ordinate is stored as 32-bit floating point value, where ‘tri_0_vertex_0_x’ represents the x co-ordinate of the first vertex (vertex 0) for the first primitive (triangle 0), ‘tri_0_vertex_0_y’ and ‘tri_0_vertex_0_z’ are the corresponding y and z co-ordinates, and so on. 36 bytes are thus required for storing each triangle primitive.

Various other primitive data or metadata may also be stored in the same data structure 1100. For instance, as shown in FIG. 11A, there is also stored in the same data structure 1100 respective bits V0, V1, V2 indicating whether the triangle primitives are valid. Also stored are respective bits O0, O1, O2 indicating whether the triangle primitives are opaque (and thus whether an “any-hit shader” should be triggered, e.g. as discussed above). Also stored is a geometry ID, GeomID, that indicates the material that the triangles represent. The geometry ID may be used by a shader program to determine how to shade (e.g. determine a colour for) the corresponding geometry.

Returning to FIG. 10A, in the present embodiments, the required triangle primitive is loaded from a data structure 1100 as shown in FIG. 11A, and the loaded data is used by the ray-triangle intersection testing circuit 75 to perform the required ray-triangle intersection testing (step 423).

In embodiments of the technology described herein, axis aligned bounding box (AABB) primitive data is stored using the same data structure that is used to store triangle primitive data. The inventors have recognised that this can allow triangle primitive and axis aligned bounding box (AABB) primitive data to be fetched and handled in the same way. This can accordingly allow the same circuits of the graphics processor 2, 60 to be used to fetch and process both triangle primitive and axis aligned bounding box (AABB) primitive data. This can save area requirements, e.g. as compared to arrangements in which separate circuits are provided to handle triangle and axis aligned bounding box (AABB) primitives.

FIG. 11B shows an example of the data structure 1101 for storing axis aligned bounding box (AABB) primitive data, according to the present embodiments. The data structure shown in FIG. 11B is the same data structure shown in FIG. 11B, and is thus a 128-byte data structure comprising 32 lines each capable of storing 32 bits. The data structure can therefore fit within two 64-byte cache lines.

It would be possible to encode the vertices of an axis aligned bounding box (AABB) primitive in the data structure 1101, and then use that data to determine whether a ray intersects the axis aligned bounding box (AABB) primitive, e.g. in a similar manner to that described above for triangle primitives.

However, in embodiments of the technology described herein, the explicit testing of whether a ray intersects an axis aligned bounding box (AABB) primitive is omitted (not performed), and instead it is assumed that a ray that has been determined to intersect a leaf node volume (e.g. by the ray-volume testing circuit 77) will intersect an axis aligned bounding box (AABB) primitive that is encompassed by that leaf node volume.

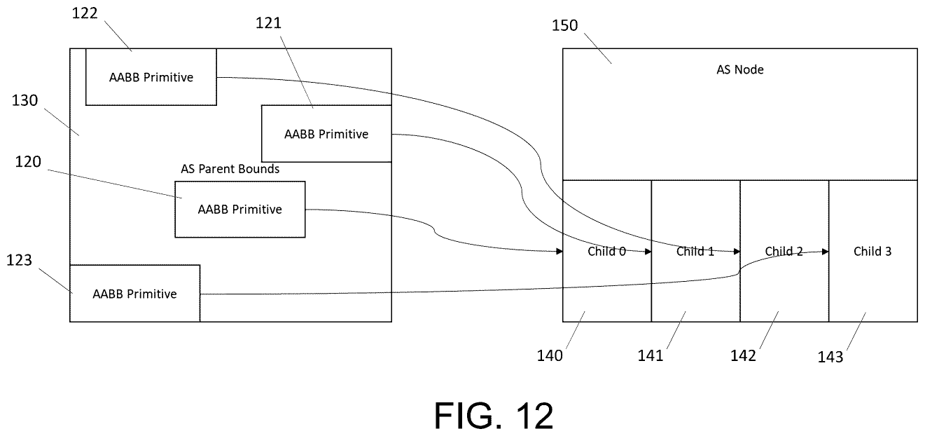

For example, FIG. 12 shows four exemplary AABB primitives 120-123 that are each encompassed by the volume of a respective leaf node 140-143, with the leaf nodes 140-143 all sharing the same parent node 150. (It will be appreciated here that FIG. 12 is a two-dimensional representation of a three-dimensional scene, and that each AABB primitive and node will have a volume.) The four AABB primitives 120-123 are accordingly all encompassed by the volume 130 of the parent node 150. If it is determined (by the ray-volume testing circuit 77) that a ray intersects a leaf node 140-143, it is assumed that the ray will intersect the corresponding AABB primitive 120-123 (without testing the AABB to determine whether this is actually the case).

Although this assumption can result in it being assumed that an axis aligned bounding box (AABB) primitive is intersected by a ray, when in fact it is not intersected by the ray (e.g. where the axis aligned bounding box (AABB) primitive does not encompass the entirety of the leaf node volume), the inventors have found that this arrangement can reduce overall processing requirements. Furthermore, the inventors have realised that this arrangement can avoid the need to provide a dedicated circuit for performing ray-AABB intersection testing (e.g. in addition to the ray-triangle intersection testing circuit 75 and ray-volume testing circuit 77), and thus can reduce overall area requirements.

Thus, in embodiments of the technology described herein, the vertices of an axis aligned bounding box (AABB) primitive do not need to be stored or processed. Accordingly, as shown in FIG. 11B, in the present embodiment, the data structure 1101 for storing axis aligned bounding box (AABB) primitive data does not encode any vertex data. As shown in FIG. 11B, in this embodiment, only a 4-byte geometry ID, GeomID, is stored in the data structure 1101 in the same field as is used in the triangle primitive data structure 1100. The data structure 1101 then includes 31 “empty” lines, so as to maintain symmetry with the triangle primitive data structure 1100. The inventors have found that the storage space costs associated with this arrangement are outweighed by the associated reductions in processing and area requirements.

FIG. 10B is a flow diagram showing the BLAS traversal and intersection testing operations in the case of an axis aligned bounding box (AABB) primitive, according to the present embodiments. FIG. 10B illustrates BLAS traversal being performed in search of a leaf node (steps 426, 427, 428). If no BLAS leaf node can be identified, the process may return to TLAS traversal (step 420).

When (at step 427) a BLAS leaf node is identified, a request for the axis aligned bounding box (AABB) primitive data, is issued (at step 1002) to the load/store unit 76. If the data is already present locally, e.g. within a cache, it can be fetched from that location accordingly. On the other hand, if the data is not present locally, it must be obtained from memory.

In the present embodiment, the required axis aligned bounding box (AABB) primitive data (i.e. geometry ID) is loaded from a data structure 1101 as shown in FIG. 11B, and the loaded geometry ID is then passed to a shader (processing) core 61, 62 to trigger the execution of an “intersection shader” based on the loaded geometry ID (step 431).

It will be appreciated that the process for an axis aligned bounding box (AABB) primitive illustrated by FIG. 10B, is substantially the same as the process for a triangle primitive illustrated by FIG. 10A. Accordingly, in embodiments of the technology described herein, the same circuits of the graphics processor 2, 60, can be, and are, used to perform both processes. For example, the same address calculation logic can be used, the same memory transactions can be used, and data can pass through the same memory hierarchy. Furthermore, the same scheduling logic can be used, data can pass through the same data processing pipeline, and update fields in essentially the same manner. This can save area, as well as design and test effort.

Thus, referring to FIG. 6, in embodiments, triangle primitive geometry data and bounding box geometry data are loaded from the memory system 68 (i.e. step 1001 of FIG. 10A and step 1002 of FIG. 10B are performed) using the same memory management unit 63, and cache system 64, 70, 69, 76. Loaded primitive geometry data and bounding box geometry data is processed (i.e. step 423 of FIG. 10A and step 431 of FIG. 10B are performed) using the same processing circuits, e.g. RTU 74 and programmable execution unit 65.

The foregoing detailed description has been presented for the purposes of illustration and description. It is not intended to be exhaustive or to limit the technology to the precise form disclosed. Many modifications and variations are possible in the light of the above teaching. The described embodiments were chosen in order to best explain the principles of the technology and its practical application, to thereby enable others skilled in the art to best utilise the technology in various embodiments and with various modifications as are suited to the particular use contemplated. It is intended that the scope be defined by the claims appended hereto.

1. A method of operating a graphics processor that is operable to perform ray tracing using a ray tracing acceleration data structure that comprises a plurality of nodes, wherein each node of the ray tracing acceleration data structure represents a respective volume, and one or more of the nodes of the ray tracing acceleration data structure is associated with geometry that falls within the respective volume that the respective node represents;
wherein the graphics processor is operable to trace a ray by traversing the ray tracing acceleration data structure and testing the ray against volumes represented by nodes of the ray tracing acceleration data structure to determine whether the ray intersects the volumes, and when it is determined that the ray intersects a volume represented by a node of the ray tracing acceleration data structure that is associated with geometry that falls within the volume that the node represents, testing the ray against the geometry to determine whether the ray intersects the geometry;
the method comprising, the graphics processor:
when it is determined that a ray intersects a volume represented by a node of the ray tracing acceleration data structure that is associated with a bounding volume primitive, omitting testing the ray against the bounding volume primitive to determine whether the ray intersects the bounding volume primitive.

2. The method of claim 1, comprising determining whether the ray intersects geometry defined within the bounding volume primitive without testing the ray against the bounding volume primitive to determine whether the ray intersects the bounding volume primitive.

3. The method of claim 2, comprising:
when it is determined that a ray intersects a volume represented by a node of the ray tracing acceleration data structure that is associated with a polygon, loading polygon geometry data stored for the node, and using the loaded polygon geometry data to test the ray against the polygon to determine whether the ray intersects the polygon, wherein the polygon geometry data is stored using a predefined data structure; and
when it is determined that a ray intersects a volume represented by a node of the ray tracing acceleration data structure that is associated with a bounding volume primitive, loading geometry data stored for the node, and using the loaded geometry data to determine whether the ray intersects, and/or how the ray should interact with, the geometry defined within the bounding volume primitive, wherein the geometry data is stored using the predefined data structure that is used to store polygon geometry data.

4. The method of claim 3, wherein the graphics processor comprises a geometry data loading circuit operable to load geometry data stored for a node of a ray tracing acceleration data structure; and the method comprises:
the geometry data loading circuit loading polygon geometry data stored for a node of the ray tracing acceleration data structure that is associated with a polygon for processing; and
the geometry data loading circuit loading bounding volume geometry data stored for a node of the ray tracing acceleration data structure that is associated with a bounding volume primitive for processing.

5. The method of claim 3, wherein the predefined data structure is configured to store at least information indicating vertex positions of a set of one or more polygons.

6. The method of claim 3, wherein the predefined data structure has a size equal to an integer number of cache entries.

7. The method of claim 3, wherein the predefined data structure comprises a set of fields configured to store polygon geometry data, and the method comprises using a same field to store geometry data for a node associated with a bounding volume primitive as is used to store corresponding polygon geometry data.

8. The method of claim 3, wherein geometry data stored for a node associated with a bounding volume primitive does not include any data indicating vertex positions of the bounding volume primitive.

9. A method of providing a ray tracing acceleration data structure for use by a graphics processor that is operable to perform ray tracing using a ray tracing acceleration data structure that comprises a plurality of nodes, wherein each node of the ray tracing acceleration data structure represents a respective volume, and one or more of the nodes of the ray tracing acceleration data structure is associated with geometry that falls within the respective volume that the respective node represents;
wherein the graphics processor is operable to trace a ray by traversing the ray tracing acceleration data structure and testing the ray against volumes represented by nodes of the ray tracing acceleration data structure to determine whether the ray intersects the volumes, and when it is determined that the ray intersects a volume represented by a node of the ray tracing acceleration data structure that is associated with a polygon that falls within the volume that the node represents, load polygon geometry data stored for the node, and process geometry using the loaded polygon geometry data, wherein the polygon geometry data is stored using a predefined data structure;
the method comprising:
generating a ray tracing acceleration data structure for use by the graphics processor, wherein the ray tracing acceleration data structure comprises a plurality of nodes, wherein each node of the ray tracing acceleration data structure represents a respective volume, and one or more of the nodes of the ray tracing acceleration data structure is associated with a bounding volume primitive that falls within the respective volume that the respective node represents; and
storing, for each node of the ray tracing acceleration data structure that is associated with a bounding volume primitive, geometry data using the predefined data structure that is used to store polygon geometry data.

10. A non-transitory computer readable storage medium storing software code which when executing on a processor performs the method of claim 9.

11. A graphics processor that is operable to perform ray tracing using a ray tracing acceleration data structure that comprises a plurality of nodes, wherein each node of the ray tracing acceleration data structure represents a respective volume, and one or more of the nodes of the ray tracing acceleration data structure is associated with geometry that falls within the respective volume that the respective node represents;
the graphics processor comprising:
a ray-volume intersection testing circuit operable to test a ray against a volume represented by a node of a ray tracing acceleration data structure to determine whether the ray intersects the volume;
a ray-geometry intersection testing circuit operable to test a ray against geometry that a node of a ray tracing acceleration data structure is associated with to determine whether the ray intersects the geometry; and
a ray tracing circuit operable to trace a ray by traversing a ray tracing acceleration data structure and causing the ray-volume intersection testing circuit to test the ray against volumes represented by nodes of the ray tracing acceleration data structure to determine whether the ray intersects the volumes, and when it is determined by the ray-volume intersection testing circuit that the ray intersects a volume represented by a node of the ray tracing acceleration data structure that is associated with geometry that falls within the volume that the node represents, causing the ray-geometry intersection testing circuit to test the ray against the geometry to determine whether the ray intersects the geometry;
wherein the graphics processor is operable to:
when it is determined by the ray-volume intersection testing circuit that a ray intersects a volume represented by a node of a ray tracing acceleration data structure that is associated with a bounding volume primitive, omit testing the ray against the bounding volume primitive to determine whether the ray intersects the bounding volume primitive.

12. The graphics processor of claim 11, wherein the graphics processor is operable to determine whether the ray intersects geometry defined within a bounding volume primitive without the ray-geometry intersection testing circuit testing the ray against the bounding volume primitive to determine whether the ray intersects the bounding volume primitive.

13. The graphics processor of claim 12, wherein the graphics processor is operable to:
when it is determined by the ray-volume intersection testing circuit that a ray intersects a volume represented by a node of a ray tracing acceleration data structure that is associated with a polygon, load polygon geometry data stored for the node, and use the loaded polygon geometry data to test the ray against the polygon to determine whether the ray intersects the polygon, wherein the polygon geometry data is stored using a predefined data structure; and
when it is determined by the ray-volume intersection testing circuit that a ray intersects a volume represented by a node of a ray tracing acceleration data structure that is associated with a bounding volume primitive, load geometry data stored for the node, and use the loaded geometry data to determine whether the ray intersects, and/or how the ray should interact with, the geometry defined within the bounding volume primitive, wherein the geometry data is stored using the predefined data structure that is used to store polygon geometry data.

14. The graphics processor of claim 13, wherein the predefined data structure is configured to store at least information indicating vertex positions of a set of one or more polygons.

15. The graphics processor of claim 13, wherein the predefined data structure has a size equal to an integer number of cache entries.

16. The graphics processor of claim 13, wherein the predefined data structure comprises a set of fields configured to store polygon geometry data, and a same field is used to store geometry data for a node associated with a bounding volume primitive as is used to store corresponding polygon geometry data.

17. The graphics processor of claim 13, wherein geometry data stored for a node associated with a bounding volume primitive does not include any data indicating vertex positions of the bounding volume primitive.

18. A graphics processor that is operable to perform ray tracing using a ray tracing acceleration data structure that comprises a plurality of nodes, wherein each node of the ray tracing acceleration data structure represents a respective volume, and one or more of the nodes of the ray tracing acceleration data structure is associated with geometry that falls within the respective volume that the respective node represents;
the graphics processor comprising:
a ray-volume intersection testing circuit operable to test a ray against a volume represented by a node of a ray tracing acceleration data structure to determine whether the ray intersects the volume;
a geometry data loading circuit operable to load polygon geometry data stored for a node of a ray tracing acceleration data structure, wherein the polygon geometry data is stored using a predefined data structure; and
a ray tracing circuit operable to trace a ray by traversing a ray tracing acceleration data structure and causing the ray-volume intersection testing circuit to test the ray against volumes represented by nodes of the ray tracing acceleration data structure to determine whether the ray intersects the volumes, and when it is determined by the ray-volume intersection testing circuit that the ray intersects a volume represented by a node of the ray tracing acceleration data structure that is associated with a polygon that falls within the volume that the node represents, cause the geometry data loading circuit to load polygon geometry data stored for the node, and cause geometry to be processed using the loaded polygon geometry data;
wherein the graphics processor is operable to:
when it is determined by the ray-volume intersection testing circuit that a ray intersects a volume represented by a node of a ray tracing acceleration data structure that is associated with a bounding volume primitive, cause the geometry data loading circuit to load geometry data stored for the node, and cause geometry to be processed using the loaded geometry data, wherein the geometry data is stored using the predefined data structure that is used to store polygon geometry data.
